(19) United States
(12) Patent Application Publication
(10) Pub. No.: US 2004/0095956 A1
(43) Pub. Date: May 20, 2004

(54) Telecommunications interface

(76) Inventors: Richard E. Henderson, Ridley Park, PA (US); Gary L. Gustine, Bonham, TX (US); Hans J. Ziegler, Milwaukee, WI (US); Louis V. Zoppel, Furlong, PA (US); G. Linton Sheppard, Huntingdon Valley, PA (US)

Correspondence Address: Raffi Gostanian, Jr., Jackson Walker, L.L.P., Suite 600, 2435 North Central Expressway, Richardson, TX, 75080, US

(21) Appl. No.: 10/631,096

(22) Filed: Jul. 31, 2003

Related U.S. Application Data
(60) Provisional application No. 60/424,277, filed on Nov. 6, 2002.

(51) Int. Cl. H04L 12/66

(52) U.S. Cl. 370/463

(57) ABSTRACT

A Digital Subscriber Line (DSL) transport can be extended economically by a retrofit cabinet which can replace a standard telephone cross-connect cabinet or by placement of a new cross-connect cabinet. The retrofit cabinet or new cabinet incorporates within it a Digital Subscriber Line Access Multiplexer (DSLAM). The inclusion of the DSLAM in the same cabinet with the cross-connect blocks avoids problems associated with real estate acquisition and approvals, avoids problems resulting from crosstalk, and avoids the necessity of replacing older feeder cabling that is incapable of carrying DSL signals. With pre-wired connections between the cross-connect blocks and the DSLAM electronics, it is possible to provide DSL transport to a subscriber by cross-connecting readily accessible terminals within the cabinet. The retrofit cabinet may also have additional feeder and distribution connection blocks for expansion of telephone service as well as DSL transports to new subscribers.

### CROSS REFERENCE TO RELATED APPLICATIONS

The present application is related to and claims the benefit of U.S. Provisional Patent Application No. 60/424,277 filed Nov. 6, 2002, and entitled TELECOMMUNICATIONS INTERFACE. Applicants hereby claim the benefit of this Provisional Patent Application under 35 U.S.C. Section 119(e), the entire contents of which are incorporated by reference herein.

### FIELD OF THE INVENTION

This invention relates to telecommunications equipment, and particularly to improvements in distribution of broadband digital telecommunications service, especially Digital Subscriber Line (DSL) transport.

### BACKGROUND OF THE INVENTION

Much of the telephone service in the United States is set up under the so-called “Serving Area Concept,” or SAC, which was devised by the Bell Telephone System to overcome some of the disadvantages of idle pairs resulting from dedicated terminations at a Central Office. In accordance with SAC, instead of running subscriber lines all the way from the subscriber to the Central Office, dedicated distribution networks, serving home, and business subscribers, were terminated at a Cross-Connect Cabinet, also sometimes referred to as a “Serving Area Interface” (SAI) or a “Feeder Distribution Interface” (FDI). A feeder cable is typically used to connect the Cross-Connect Cabinet to the Central Office. In some areas, the feeder cable is connected from a Remote Terminal (RT) to the Cross-Connect. Cabinet, which is an extension of the Central Office. The RT contains a cabinet or other enclosure that houses the Digital Loop Carrier (DLC) electronics necessary to provide telephone service to a new Carrier Serving Area (CSA). A CSA is the serving area originally devised by the Bell Telephone System that could be served by the then available electronics, which extended to a distance of up to 12,000 feet from the electronics. As newer electronics were developed, the service area was able to extend to a distance of approximately 18,000 feet from the electronic equipment. This new area was called the Extended Carrier. Serving Area (ECSA). The predominant types of enclosures deployed at RTs are known as Digital Loop Carrier (DLC) Cabinets, Controlled Environmental Vaults (CEV), and Huts. RTs may serve plural SAIs. Since the predominant RTs deployed are of the DLC Cabinet type, references herein to RTs will be to RTs of the DLC Cabinet type.

The feeder cable to the Cross-Connect Cabinet is spliced to cables behind the feeder terminal blocks in the cabinet and is accessible at a feeder block field on the front of the blocks in the cabinet. Dedicated connections are provided, through drop wires and/or distribution cables, from distribution blocks in the cabinet to home and business subscribers. Cross-connects are made between the feeder blocks and the distribution blocks to interconnect the subscribers to the feeder in order to provide telephone service. Currently, some of the Cross-Connect Cabinets in the telephone system are operating at or near full capacity, and require upgrading. Additionally, some of the Cross-Connect Cabinets are in deteriorating condition, or have deteriorating wiring insulation or terminal block material, and need to be retrofitted or replaced.

Digital Subscriber Line (DSL) transport provides a telephone subscriber with moderately high speed, two-way, data communication over existing telephone lines, i.e., unshielded twisted pairs. More specifically, DSL is a transport over which different broadband and narrowband services can be carried. Current DSL transport is known as ADSL or “Asymmetric Digital Subscriber Line” service. The standard speed in the direction from the Central Office to the subscriber is 6.144 MBs, although higher rates are achievable. The speed in the direction from the subscriber to the Central Office may vary over a wide range, although it is generally from 160 KBs to 640 KBs. More advanced DSL transports, known as VDSL (Very High Speed Data Rate Digital Subscriber Line) and XDSL (which refers to different variations of DSL, such as ADSL, HDSL, SDSL, ADSL 2, and ADSL 2+) transports are under development, but have not yet been implemented.

Still other broad band services, such as G.Lite, are under development. G.lite is a lower-speed, lower-cost variant of ADSL that can be self-installed by the customer and rapidly deployed by service providers. G.lite was approved as a standard by the ITU (G992.2) in June 1999 and can offer speeds of up to 1.5 Mbps downstream and up to 512 Kbps upstream. G.lite was designed to provide this service over existing phone lines without the POTS splitter usually required by full-rate ADSL. The G.lite standard features a technique known as “fast retrain”, which limits the upstream power of the G.lite signal when a telephone handset is in use. The “fast retrain” feature of G.lite dynamically detects off-hook and on-hook conditions on the customer's telephone line. When the line is off-hook; i.e. a voice conversation is in progress, the G.lite transceiver automatically shifts the frequency of the data signal and attenuates the lower frequencies to prevent interference with the voice signal. When the line goes back on-hook, the digital signal is dynamically shifted back to lower frequencies to provide the maximum sustainable data rate.

Most DSL transport is currently provided through electronic equipment located at a telephone company's Central Office. Transmission constraints for DSL transport include limiting the distance between the DSL electronic equipment and the subscriber to a maximum of about 18,000 feet (and typically less than 18,000 feet in practice). Therefore, DSL transport is generally unavailable to customers located outside the 18,000 foot range from a Central Office. Moreover, the speed of DSL transport is distance-dependent, in that the transceivers at both ends of a DSL subscriber line automatically adjust the data rates in both directions downward until reliable communication can be achieved. Therefore, it is desirable to locate the electronic equipment as close as possible to the subscribers in order to provide high speed service. Electronic equipment providing DSL transport can be located remotely from the Central Office. However, where the DSL equipment is remote from a Central Office, and also remote from other RT sites interposed between the Central Office and the subscribers, significant additional cabling is needed in order to provide DSL transport to the subscribers.

An alternative approach is to provide an additional cabinet, near the Cross-Connect Cabinet, to house the DSL electronic equipment. The additional cabinet can be provided, for example, at or near an RT site, where DLC electronics are present to serve one or several Cross-Connect Cabinets from a Central Office or another RT site.

There are several practical obstacles that discourage this approach. One is that it would be necessary in some cases to purchase additional real estate for the DSL electronic equipment cabinet. Another is that obtaining the necessary approvals from local authorities is time-consuming and expensive.

Still another problem is that cabling is required between the Cross-Connect Cabinet and the DSL electronic equipment. If multiple DSL signals are carried in a cable within the same shield over a distance, interference known as “crosstalk” may result. The interference increases as the distance between the Cross-Connect Cabinet and the DSL cabinet increases. The crosstalk problem not only imposes limitations on the cable length, but also imposes special requirements on the cabling as well as on the number of pairs in the cable that can be utilized for DSL transport. In many cases, the cable or cables between the Cross-Connect Cabinet and the DSL electronic cabinet carry both DSL and conventional telephone signals, known as “POTS” or “Plain Old Telephone Service.” In such a case, the crosstalk between the DSL pairs in the cable increases with increasing cable length, and it becomes necessary to eliminate some of the number of DSL pairs in the cable. If this is not done, the crosstalk, which is the result of a phenomenon called intermodulation, has the effect of causing DSL signal distortion or total loss of data transmission. Crosstalk may also cause background noise that will affect the clarity of the voice transmission over the POTS lines.

Another problem is that cabinets that are currently available to house DSL electronic equipment require “hardened” electronic equipment, that is, equipment that is capable of operating over an extended temperature range, typically −40° F. to 150° F. Hardened equipment is considerably more expensive than conventional electronic equipment. A further problem exists in the case of “Embedded Plant”, a term referring to existing cabling and cabinets currently deployed by the telephone companies. Some of the cabling still in use between Central Offices (or RT sites) and SAIs is older, and in some cases, paper insulated cable. This type of cable was used before plastic insulated cable was placed into service. In many cases, the paper insulation around the transmission wires has become wet and has deteriorated. This deteriorated condition has some detrimental effect on the ability of the cable to transmit POTS service, but renders the cable incapable of handling the much greater bandwidth required for DSL transport. Additionally, most DLC Cabinets that have been deployed at RT sites (and are still being deployed at many RT sites) are filled with POTS electronics and have no room available for additional electronic equipment such as DSL electronics.

### BRIEF SUMMARY OF THE INVENTION

The general object of this invention is to address and overcome one or more of the aforementioned problems. More specifically, an object of this invention is to provide a telecommunications interface that increases the speed of DSL transport, and makes such service available to virtually all subscribers within the service area of an SAI. It is also an object of the invention to provide a method of retrofitting or rehabilitating an existing Cross-Connect Cabinet in order to provide DSL transport, and, optionally, to expand the number of subscribers (by providing additional Cross-Connect space) that can be served by the Cross-Connect Cabinet.

The telecommunications interface in accordance with the invention comprises an enclosure, and feeder and distribution blocks within the enclosure. The enclosure is preferably an environmental enclosure. The distribution blocks are connected to a plurality of subscribers through subscriber lines, and the feeder blocks are connected to a telecommunications trunk. The feeder and distribution blocks are cross-connected to provide voice telecommunications services to the subscribers. A DSL Access Multiplexer (DSLAM), a Broadband Loop Carrier (BLC), or other broadband electronic multiplexer, is incorporated into the enclosure, along with the feeder and distribution blocks, and connected to a provider through a high-speed interface. The electronic unit is connected through plural data connections to the distribution blocks, thereby providing high speed, digital telecommunications service to selected subscribers. The interface described above may be established by either retrofitting or rehabilitating an existing Cross-Connect Cabinet.

Locating a DSLAM in the same enclosure with the feeder and distribution blocks places the DSLAM closer to customers and thus increases the number of customers that can be serviced by a DSL transport. Further, certain adverse effects of crosstalk, occurring in a cable bundle for example, can be mitigated. An existing Cross-Connect Cabinet can be readily retrofitted to locate the DSLAM in the same enclosure with the feeder and distribution blocks. In most instances, retrofitting avoids the problem of acquiring additional real estate.

Although a splitter is unnecessary if only a data service is to be provided, the telecommunications interface may include a splitter within the enclosure, such as a remote cabinet to allow a data signal to be separated from an analog voice line so data and voice can independently be routed. The DSLAM is connected to the splitter, and at least selected terminals of the feeder blocks are also connected to the splitter. The plural data connections to the distribution blocks are constituted by connections from the splitter to the distribution blocks so that selected subscribers connected to the distribution blocks are provided with both voice and DSL transport over the same subscriber lines.

The enclosure is preferably divided into compartments, the number of which is dependent on the desired configuration of access to the cross-connect blocks, access to the electronics and the particulars of the site on which the cabinet is to be located. One or more compartments will contain the feeder and distribution blocks. The remaining compartment or compartments contain the DSLAM. In a preferred embodiment of the invention, plural, pre-wired, data connections extend from one compartment to another for connection of the DSLAM to the cross-connect blocks. At the time of installation or retrofitting, the number of these plural connections will ordinarily exceed the number of subscribers, and accordingly, DSL transport can be provided later to additional subscribers by cross-connects made solely in the compartment or compartments containing the feeder and distribution blocks. The compartments can be made separately lockable, so that access can be denied to a worker who is only authorized to have access to one or more, but not all, of the compartments.

Where the compartment containing the DSLAM also houses a splitter for providing various DSL transports, plural, prewired, voice connections, which may exceed the number of subscribers, can be provided from new feeder blocks in one compartment to the splitter in an electronic compartment. In this arrangement, both DSL transport by itself, and, for example ADSL transport, can be provided to additional subscribers by cross-connects made solely in the compartment or compartments containing the feeder and distribution blocks.

A conventional telecommunications SAI may be retrofitted for incorporation of DSL transport, without service interruption, by removing an existing Cross-Connect Cabinet while retaining the original feeder and distribution blocks and their connections, and substituting for the removed cabinet a new Cross-Connect Cabinet, the interior of which is divided into compartments. One or more compartments of the new cabinet can house the feeder and distribution blocks and may also house additional distribution blocks for growth, as well as additional blocks pre-wired to the DSLAM, or to the splitter if one is used. The DSLAM, and splitter if used, are installed in one or more of the other compartments, and interconnections are provided between the DSLAM or splitter and the feeder and distribution blocks.

Other objects, details and advantages of the invention will be apparent from the following detailed description when read in conjunction with the drawings.

### BRIEF DESCRIPTION OF THE DRAWINGS

For simplicity, the drawings show Cross-Connect Cabinets which are “single-sided” before retrofitting, that is, their feeder and distribution blocks are all accessible through a door on one side of the cabinet. The drawings also show only DLC Cabinets at the RT site, although, as mentioned, other electronic enclosures may be located at an RT site. The DSL electronics, added by retrofitting in accordance with the invention, are disposed in the opposite side of the cabinet, and accessible through a door or removable panel on that side. As later discussed, the invention can be embodied in cabinets having various other configurations.

FIG. 1 is a schematic diagram illustrating a typical DLC Cabinet RT site, including an SAI communicating with a telephone Central Office;

FIG. 2 is a schematic diagram illustrating a typical SAC site, having only a Cross-Connect Cabinet;

FIG. 3 is a schematic diagram illustrating the feeder and distribution blocks in a Cross-Connect Cabinet served by a DLC Cabinet at an RT site as shown in FIG. 1;

FIG. 4 is a schematic diagram illustrating the Cross-Connect Cabinet of FIG. 3 in top plan view;

FIG. 5 is a schematic diagram illustrating an installation in which direct DSL transport is provided by the use of DSLAM electronics remote from a Central Office, but which is subject to one or more of the problems discussed above;

FIG. 6 is a schematic diagram illustrating an installation in which VODSL transport is provided by the use of DSLAM electronics remote from a Central Office, but which is subject to one or more of the problems discussed above;

FIG. 7 is an isometric view of a conventional Cross-Connect Cabinet, with the doors removed to show the feeder and distribution blocks inside the cabinet;

FIG. 8 is an isometric view of a retrofit cabinet in accordance with the invention, with the doors open to show an expanded cross-connect field;

FIG. 9 is a schematic rear view of the retrofit cabinet of FIG. 8, illustrating the locations of compartments containing electronic equipment;

FIG. 10 is an exploded isometric view illustrating retrofitting in accordance with the invention by the addition of an expansion module to an existing Cross-Connect Cabinet;

FIG. 11 is a schematic diagram illustrating a telecommunications interface in accordance with the invention, providing direct DSL transport to a subscriber;

FIG. 12 is a schematic top view of the interface of FIG. 11;

FIG. 13 is a schematic diagram illustrating a telecommunications interface in accordance with the invention;

FIG. 14 is a schematic top view of the interface of FIG. 13;

FIG. 15 is a schematic diagram illustrating a telecommunications interface in accordance with the invention, providing direct DSL transport to a subscriber, in which wired voice and data connections are provided in order to allow DSL transport to be provided to additional subscribers by cross-connects made solely on the side of the cabinet containing the feeder and distribution blocks;

FIG. 16 is a schematic top view of the interface of FIG. 15;

FIG. 17 is a schematic diagram illustrating a telecommunications interface similar to that of FIG. 15, but in which VODSL transport is provided to a subscriber; and

FIG. 18 is a schematic top view of the interface of FIG. 17.

FIG. 19 is a schematic diagram illustrating an indoor building entrance terminal;

FIG. 20 is a schematic diagram illustrating an indoor building entrance terminal comprising two distinct and separate partitions;

FIG. 21 is a schematic diagram illustrating an outdoor building entrance terminal;

FIG. 22 is a schematic diagram illustrating an outdoor building entrance terminal comprising two distinct and separate partitions;

FIG. 23 is a schematic diagram illustrating an outdoor aerial terminal;

FIG. 24 is a schematic diagram illustrating an outdoor aerial terminal comprising two distinct and separate partitions;

FIG. 25 is a diagram illustrating a cabinet control center functionality;

FIG. 26 is a schematic diagram illustrating a 1200 pair cabinet of the present invention is depicted on a cross-connect side;

FIG. 27 is a schematic diagram illustrating a 1200 pair cabinet of the present invention is depicted on a cross-connect side;

FIG. 28 is a schematic diagram illustrating a 1200 pair cabinet of the present invention is depicted on an electronic side with, for example, an installed 240 port IP DSLAM;

FIG. 29 is a schematic diagram illustrating a 1200 pair cabinet of the present invention is depicted on an electronic side with, for example, an installed 250 port MRT;

FIG. 30 is a schematic diagram illustrating a 1200 pair cabinet of the present invention is depicted on an electronic side with, for example, an installed MRT;

FIG. 31 is a schematic diagram illustrating a 1200 pair cabinet of the present invention is depicted on a cross-connect side with, for example, an installed binding post frame.

FIG. 32 is a schematic diagram illustrating a small cabinet adapted to provide ADSL functionality, for example, of the present invention is depicted;

FIG. 33 is a schematic diagram illustrating a 1200 pair cabinet adapted to provide ADSL functionality, for example, of the present invention is depicted. 480 port IP DSLAMs are installed in a back side of the cabinet (which is shown with it's doors removed). It should be noted that the heat exchanger is preferably coupled to or integrated with one or more of the doors;

FIG. 34 is a schematic diagram illustrating a medium cabinet adapted to provide ADSL functionality, for example, of the present invention is depicted; and

FIG. 35 is a schematic diagram illustrating a large cabinet adapted to provide ADSL functionality, for example, of the present invention is depicted.

### DETAILED DESCRIPTION OF THE PREFERRED EMBODIMENT

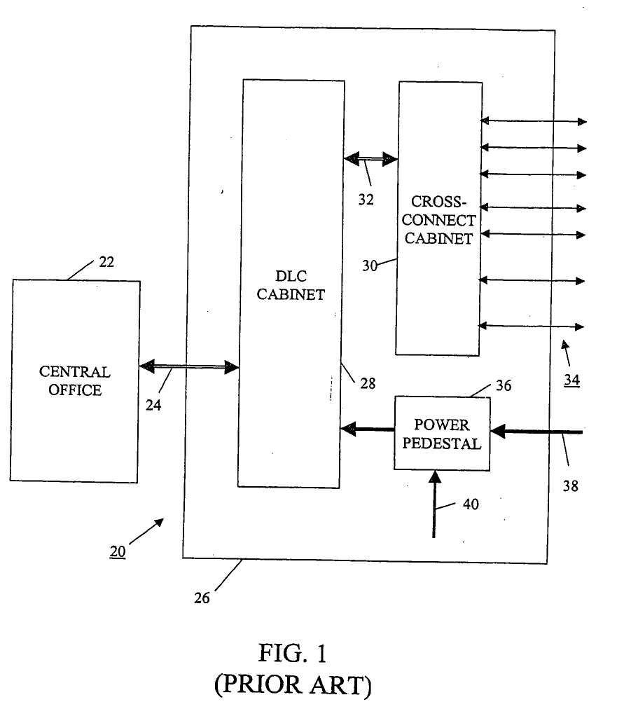

A typical conventional RT site 20, as shown in FIG. 1, is connected to a telephone Central Office 22 (or to another remote site) though a high speed, multiplexed, digital connection 24, which can take any of a variety of forms, such as a wired cable of twisted pairs, a coaxial cable, a fiber optic cable, a microwave link or other transmission link. The elements of the RT site depicted in FIG. 1 are typically situated on a concrete pad 26, and include a DLC Cabinet 28, which provides an analog/digital interface between the digital connection 24 and the subscribers served by the RT site. A Cross-Connect Cabinet 30, also provided on the concrete pad, is connected to the DLC Cabinet 28 by a cable 32, and provides the interconnections between the DLC Cabinet and the subscribers served by the RT site 20 through subscriber lines 34. A typical Cross-Connect Cabinet may serve, for example, up to 400 subscribers. However, the maximum number of subscribers may vary depending on the size of the cabinet and the capabilities of the connection blocks contained in the cabinet.

The electronic equipment in the DLC Cabinet is powered, through a unit 36, known as a “power pedestal,” which includes a power transfer switch for providing alternative connections to an electric power company through power line 38, or, in the event of a power failure, to an emergency generator (not shown) through power line 40.

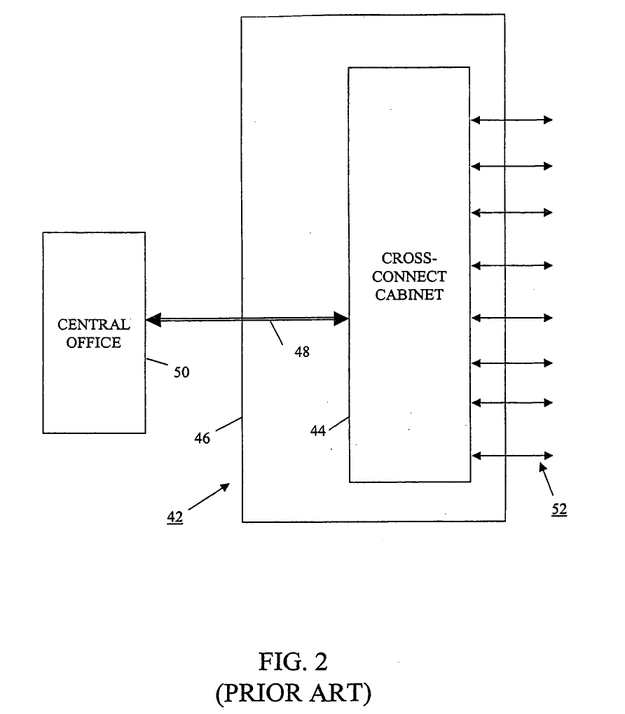

The SAC site 42 shown in FIG. 2 comprises a Cross-Connect Cabinet 44 mounted on a concrete pad 46. The Cross-Connect Cabinet is connected through a cable 48 to a Central Office 50, and serves subscribers through subscriber lines 52. The cable 48, instead of being connected directly to a Central Office, may be connected to an electronic cabinet at an RT site, such as a DLC Cabinet (not shown in FIG. 2), a Controlled Environmental Vault (CEV), a Hut, or other electronic enclosure, any of which may serve more than one SAC site.

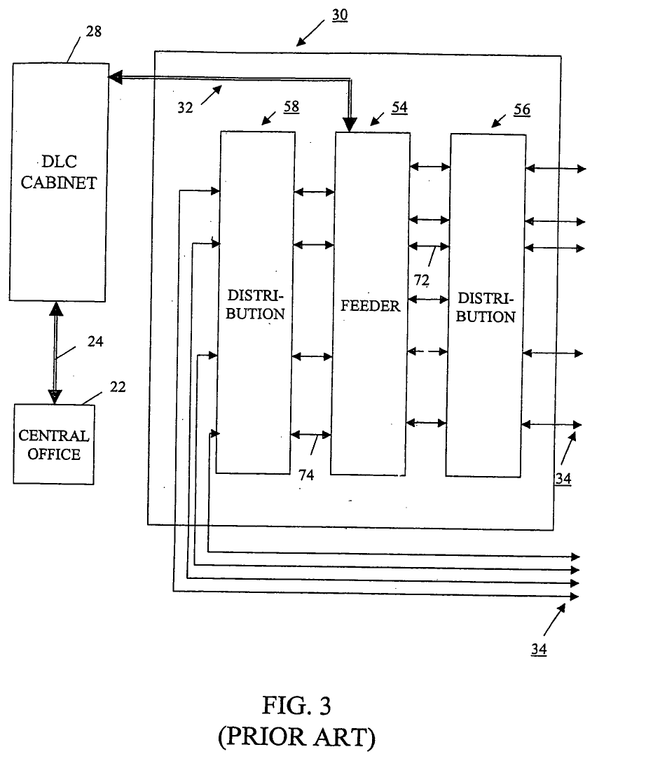

As shown in FIG. 3, a wiring frame, comprising feeder and distribution blocks, is installed inside Cross-Connect Cabinet 30. In this configuration, a bank 54 of feeder blocks is situated between banks 56 and 58 of distribution blocks. The feeder blocks are connected to the DLC Cabinet 28 by cable 32. Subscriber lines 34 are connected to the distribution blocks in both distribution block banks 56 and 58, and the feeder blocks are connected to the distribution blocks by cross-connects, for example, cross-connect 72 and cross-connect 74.

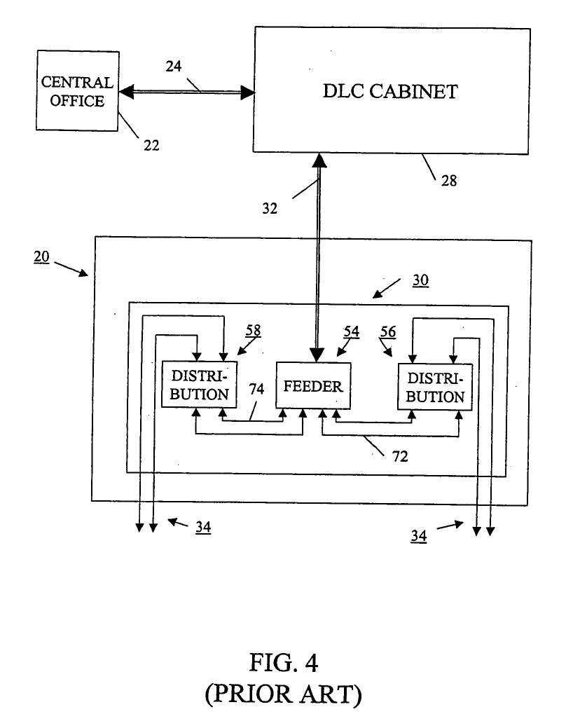

The cross-connects, e.g. 72 and 74, are made on the front of the block field, as shown in FIG. 4, whereas the subscriber lines 34 are connected to the rear of the distribution blocks and the cable 32 is connected to the rear of the feeder blocks. Because the cross-connects are made at the front of the block field it is possible for a technician to make and modify subscriber connections quickly.

As mentioned previously, extending the coverage of a DSL transport by locating the DSLAM and associated electronic equipment at a location remote from the Central Office requires additional real estate, and entails various acquisition and approval problems. This is primarily because a typical concrete pad, such as pad 46 in FIG. 2, supporting a free standing Cross-Connect Cabinet, or a pad such as pad 26 in FIG. 1, supporting a Cross-Connect Cabinet, a DLC Cabinet and a power pedestal, does not have sufficient space available for an additional electronic cabinet of the size required to contain a DSLAM and its associated equipment.

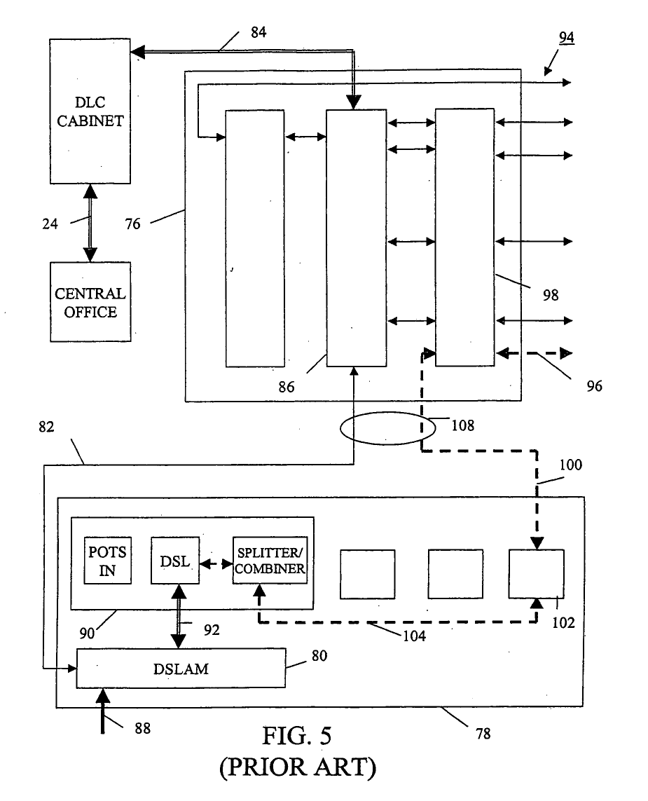

One way to extend DSL coverage is to provide a separate DSLAM cabinet as depicted in FIG. 5. A Cross-Connect Cabinet 76, which is similar to the cabinet of FIG. 3, is connected to a DSLAM cabinet 78. The DSLAM cabinet 78 may be, but is not necessarily, located in close proximity to the cross-connect cabinet. The DSLAM cabinet includes the DSLAM 80, which is connected to the Cross-Connect Cabinet by a suitable transmission medium such as T1 line 82. The T1 service is provided from the Central Office through the DLC Cabinet, cable 84, and feeder block 86 in the Cross-Connect Cabinet. Alternatively, T1 service can be connected directly to the DSLAM cabinet without going through the cross-connect cabinet.

The DSLAM and other electronic equipment in the DSLAM cabinet receives power from an electric company through a power line 88. The DSLAM cabinet also includes a splitter 90, connected to the DSLAM by a cable 92. The splitter may be, but is not necessarily, a unit separate from the DSLAM. The splitter is present in order to allow a data signal (for example, a high frequency data signal) to be separated from a voice line (for example, an analog voice lineand to provide various services. The splitter may carry data from a multi-conductor DSLAM cable 92 to one or more of subscriber lines 94. In this case, one such subscriber line, 96, is connected through a distribution block 98 and a pair 100, to a DSL block 102 in cabinet 78, and from the DSL block through pair 104 to the splitter 90. Pair 100 is part of a shielded, multi-conductor cable 108 connected between the Cross-Connect Cabinet 76 and DSLAM cabinet 80. Since cable 108 includes plural pairs carrying DSL signals, and also includes the T1 line 82, crosstalk can occur in the cable, affecting the data transmission as well as the clarity of the voice transmission in the POTS lines that are also contained in the cable. Crosstalk becomes more severe with increasing distance between the DSLAM cabinet 78 and the Cross-Connect Cabinet 76.

The arrangement shown in FIG. 5 extends the coverage of a DSL transport, making it available to any subscriber within about 18,000 feet of the DSLAM cabinet. However, it has the problem of real estate acquisition and approval for the DSLAM cabinet location, as well as the problems of crosstalk and of providing cabling between the DSLAM cabinet and the Cross-Connect Cabinet.

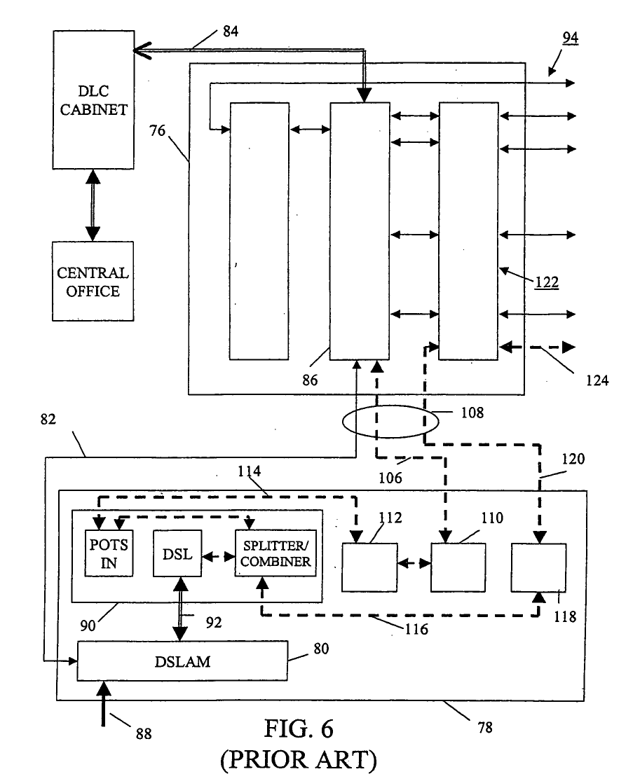

If DSL transports, such as ADSL, is provided through a DSLAM cabinet remote from the Central Office, an additional problem arises. As shown in FIG. 6 (which is similar to FIG. 5 except for additional connections), to provide DSL transport, such as ADSL, it is necessary to combine the subscriber voice service, i.e., POTS, with the DSL transport at the splitter 90, which is remote from the Cross-Connect Cabinet 78. Therefore, a POTS connection that would ordinarily be cross-connected from a feeder block directly to a distribution block to provide telephone service to a subscriber, is instead routed to the splitter through a cable extending between the Cross-Connect Cabinet and the DSLAM cabinet. The combined service is routed back to the Cross-Connect Cabinet through the same cable. In practice, many such connections are made through the same cable.

As shown in FIG. 6, POTS service intended for one subscriber is delivered through a pair 106 in cable 108 to a block 110 in the DSLAM cabinet, and connected through another DSL block 112 to the splitter 90 by connection pair 114. DSL transport is provided to the splitter through cable 92, and the POTS service and the DSL transport are combined and routed through pair 116 to DSL block 118, and from DSL block 118, through a pair 120 in cable 108, to a distribution block in bank 122 in the Cross-Connect Cabinet, and thence to a subscriber through subscriber line 124.

The presence of plural DSL connections, as well as a T1 connection or other form of transmission service, and possibly other services, in cable 108, within the same cable sheath, raises a potential problem of crosstalk, in which the various signals can interfere with one another and can affect the clarity of the voice transmission in the POTS lines that are also contained in the cable. The potential for crosstalk imposes limitations on the number of conductors that can be accommodated in a given cable sheath, and on the length of the cable. Therefore, as will be apparent from the discussion thus far, the utilization of a DSLAM cabinet as an adjunct to one or more Cross-Connect Cabinets entails two major problems: the acquisition and approval of additional real estate, and additional cabling with the potential for crosstalk.

This invention addresses the above-discussed problems by incorporating electronic equipment, for providing DSL transport to subscribers, into a Cross-Connect Cabinet. Additional equipment incorporated into the Cross-Connect Cabinet may include not only a DSLAM, but also associated components, including a splitter, as well as an environmental control unit and an electrical power source. The invention provides for retrofitting a conventional Cross-Connect Cabinet in such a way as to incorporate the DSLAM and other components, such as an AC to DC rectifier, along with the original cross-connect blocks. The invention further allows a telephone company to continue to use its automated loop testing system to test its copper pairs because the copper infrastructure to the remote cabinet feeder side is untouched. Also, the telephone company can place a test head facility for broadband and narrowband testing in the SAIC.

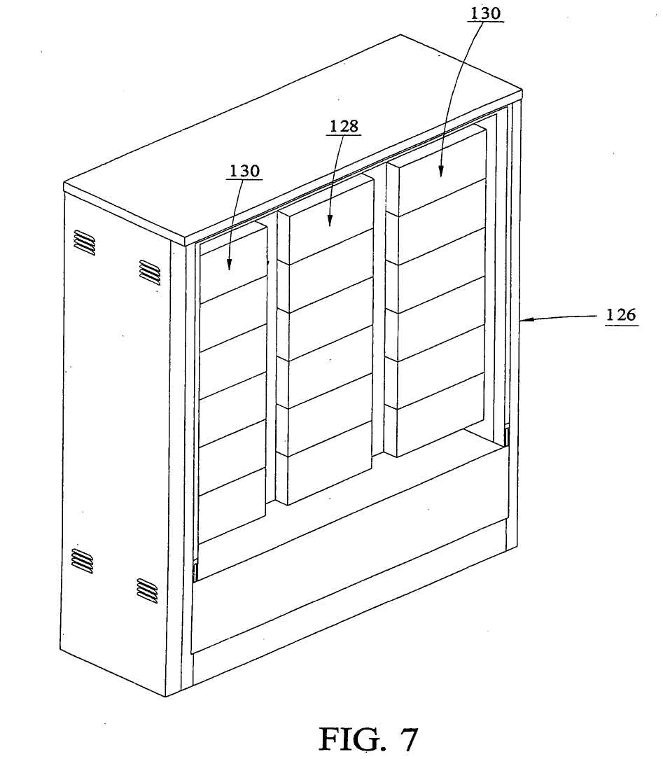

The conventional Cross-Connect Cabinet 126, as shown in FIG. 7, has an elongated rectangular shape in top plan view. The doors (not shown in FIG. 7) open to expose the front side of the feeder blocks 128 and distribution blocks 130, where cross-connects can be made. The cable (not shown) which connects to a Central Office, or to a DLC Cabinet or other RT, and the subscriber cables (not shown) are located behind the feeder and distribution blocks, and may be accessible from the rear of the cabinet through a removable rear panel. If no removable rear panel is provided, provision may be made to allow the array of blocks to swing outward, about a vertical axis, or downward, about a horizontal axis, in order to provide access to the cables and to the rear side of the blocks. The cables are provided with some slack, and the feeder and distribution blocks are supported together in the cabinet on a frame that can be removed through the doorway without disturbing either the cable connections or the cross-connects. With the wiring frame removed from the cabinet, the cabinet itself can be dismantled and removed, and replaced by another cabinet, without interrupting service to the subscribers.

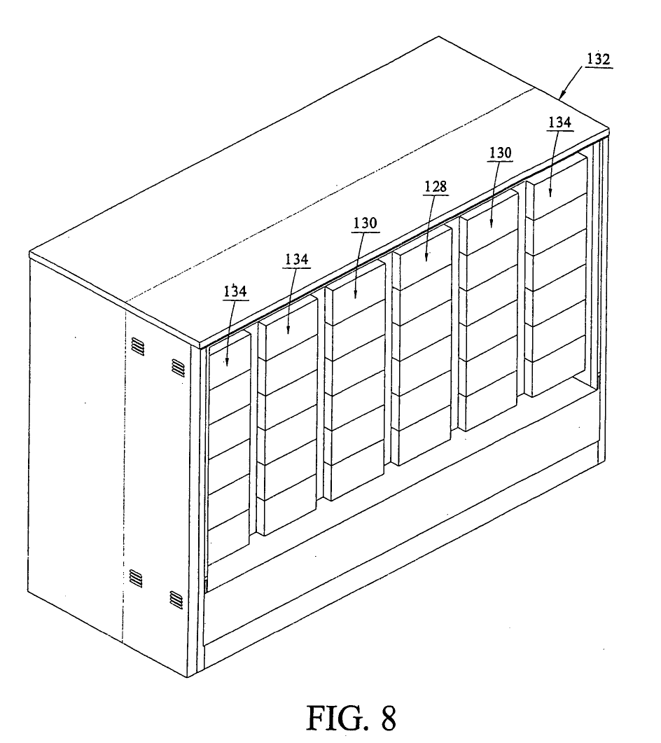

The replacement cabinet 132, as shown in FIG. 8, is a weather tight cabinet, which is either longer than the original cabinet shown in FIG. 7 (in the direction of the width of the front opening) or deeper (in the front-to-back direction). The size of the replacement cabinet will ordinarily be larger than the cabinet that it replaces, in the front to back direction, in the lengthwise direction, in height or in some combination of length, width or height in order to accommodate added electronic equipment as well as additional banks of connection blocks. The concrete pad on which the original Cross-Connect Cabinet was mounted may or may not be of sufficient size to accommodate a somewhat larger replacement cabinet. However, in general, the existing easement will be of sufficient size to allow for the cabinet to be enlarged, and for the concrete pad to be enlarged, if necessary. Thus, the replacement cabinet will usually be mountable on the same concrete pad, or on an enlarged concrete pad, as a direct substitute for the original cabinet.

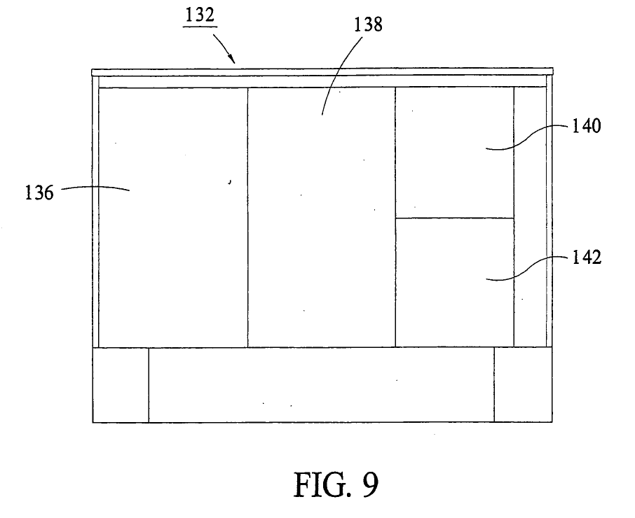

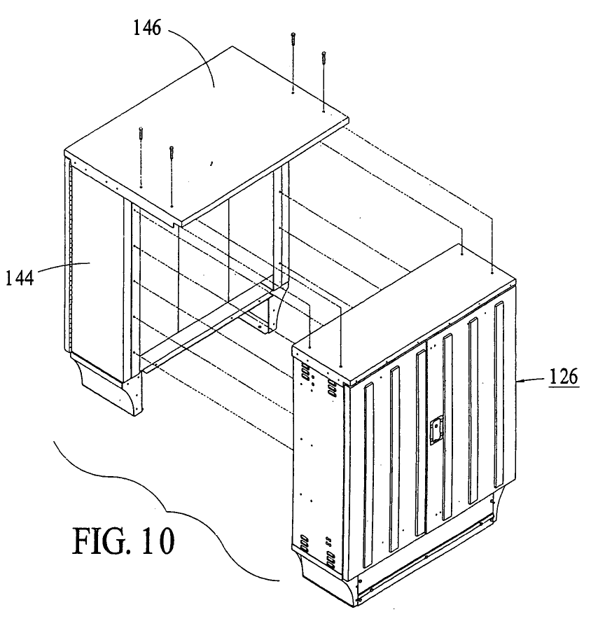

The replacement cabinet shown in FIG. 8 has additional banks 134 of feeder and distribution blocks in addition to the original blocks 128 and 130. As shown in FIG. 8, the replacement cabinet is also deeper than the original cabinet of FIG. 7, in order to provide space behind the wiring frame, and the cabling connected to the rear of the wiring frame, for the electronic equipment used to provide DSL transport, and related equipment. The cabinet 132 may have a rear access (not shown), which can allow access to the electronic equipment, which will typically include a DSLAM, a splitter, connection blocks directly associated with the DSLAM and the splitter, environmental control equipment and an electrical power source. Thus a typical replacement cabinet in accordance with the invention, as depicted in FIG. 8, has at least two separately accessible compartments: a cross-connect compartment accessible from one side, and an electronics compartment accessible from the other side. As shown in FIG. 9, the rear side of the cabinet 132 may have several compartments, for example, a compartment 136 for a DSLAM and splitter, a central compartment 138 for power supply equipment, and compartments 140 and 142 for cross-connect blocks and protection equipment. As shown in FIG. 10, which illustrates one of many possible ways to effect retrofitting of an existing cabinet 126, an expansion module 144 is secured to an existing cabinet, in place of the original rear panel (not shown). A cover 146, designed to overlie the original cabinet may be provided to ensure that rainwater cannot enter the interior of the resulting enlarged cabinet.

If the original cabinet has back-to-back banks of feeder and distribution blocks accessible respectively from opposite sides of the cabinet, the replacement cabinet may be longer than the original cabinet, and the additional equipment may be located in a space next to an end of the array of distribution blocks. In this case, if the electronic equipment is disposed adjacent to one end of the array of feeder and distribution blocks, additional growth blocks, to allow for expansion of the number of subscriber lines, may be provided adjacent to the opposite end of the original array of feeder and distribution blocks. If the original cabinet is located adjacent to a building, a fence or some other impediment to access to both sides of the cabinet, the replacement cabinet may be extended on both sides, or increased in height, or both to provide one or more readily accessible additional compartments for the additional equipment.

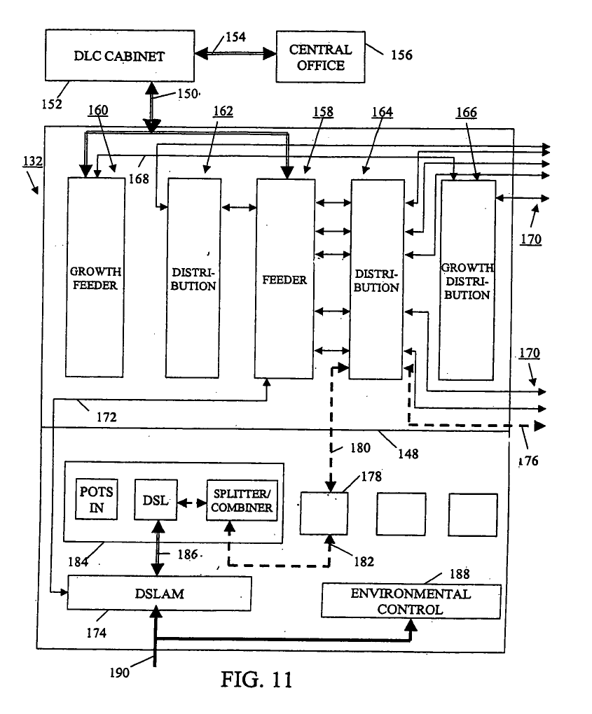

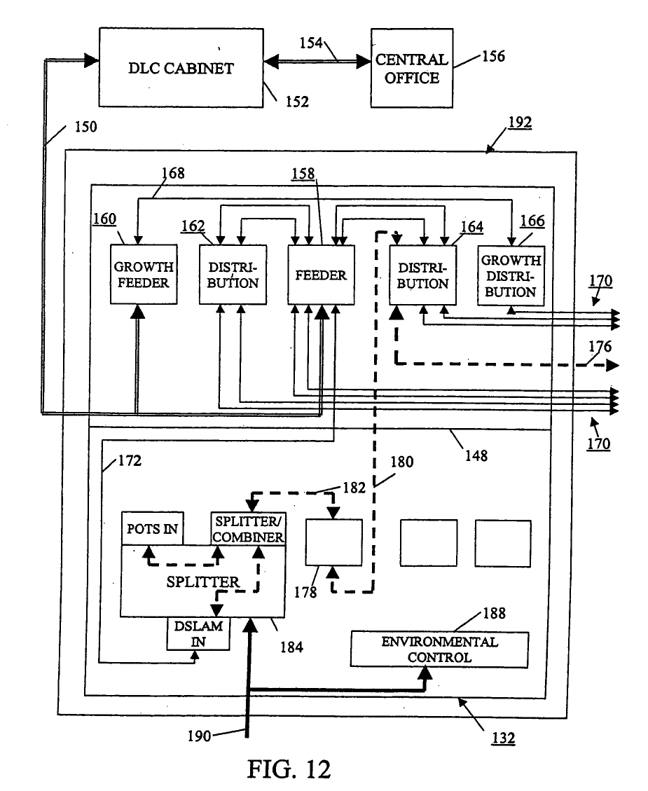

A simple embodiment of the invention is depicted in FIGS. 11 and 12, which show the contents of both compartments of a new cabinet 132, which is a replacement for an original, single-sided, Cross-Connect Cabinet. The cross-connect blocks are accessible from the cross-connect side, and are shown schematically as separated, by a line 148, from a DSLAM and the other components, which are accessible from the electronics side of the cabinet.

As shown in FIG. 11, the cabinet 132 is connected by a cable 150 to a DLC Cabinet 152, which is in turn connected through a cable 154 to a Central Office 156. The cable 150 serves a bank 158 of feeder blocks, and a bank 160 of additional feeder blocks that are optionally included to allow for growth in the number of subscribers served by the cabinet. Banks 162 and 164 of distribution blocks are provided on both sides of the feeder block bank 158, and an optional additional bank 166 of distribution blocks may be provided to allow for growth. The additional feeder blocks in bank 160 may be cross-connected to any of the distribution blocks, including bank 162, bank 164 and the additional distribution blocks in bank 166, one such cross-connect being shown at 168. The distribution blocks are connected to subscriber lines 170.

The distribution, feeder and growth block fields are preferably mounted so that they can swing out or drop down to permit access to splicing modules or other cross-connect fields behind them. Protector blocks (not shown) may also be provided within the cabinet for transient suppression and lightning protection. (00761 Data service, provided by a T1 line within cable 150, is routed through a feeder block in bank 158 and line 172 to a DSLAM 174 (FIG. 11) in the electronics side of the cabinet. In FIGS. 11 and 12, a data only DSL transport is shown provided through a subscriber line 176 from a distribution block in bank 164, which is cross-connected to a DSL block 178 in the electronics side by a cross-connect 180, which is fed from one side of the cabinet to the other. This DSL block is, in turn, connected, though a line 182, which is within a cable of lines, to a splitter 184. In this case, the splitter merely connects the DSL block 178 to the DSLAM 174 through a service cable 186 (FIG. 11), since the service provided to the subscriber on line 176 is a data only DSL transport. Cross-connects can be provided between the cross-connect and electronics compartments of the cabinet to provide a data only DSL transport to multiple subscribers. The connections made from one side of the cabinet to the other side in FIGS. 11 and 12 can be made through cables that are relatively short, typically only about three to six feet in length, that may minimize crosstalk and can be shielded.

An environmental control unit 188 may be provided in the electronics compartment to maintain the temperature and humidity in the electronics compartment within the operating range for conventional (non-hardened) electronic components. Electrical power to the DSLAM 174, the splitter 184, and the environmental control unit 188 is provided through cable 190. Optionally, a standby battery power supply (not shown) can be located within the cabinet in order to provide uninterrupted DSL transport to subscribers in the event of a electrical power failure.

FIG. 12 shows a concrete pad 192 on which the cabinet 132 is situated, and also depicts the sides of the banks of blocks on which the various connections are made. As will be apparent, on the cross-connect side of the cabinet, cross-connects between the various feeder and distribution blocks are made on the side which is immediately accessible through the doors, while connections to the cabling from the DLC Cabinet and distribution cables, which are permanent connections, are made on the rear sides of the blocks.

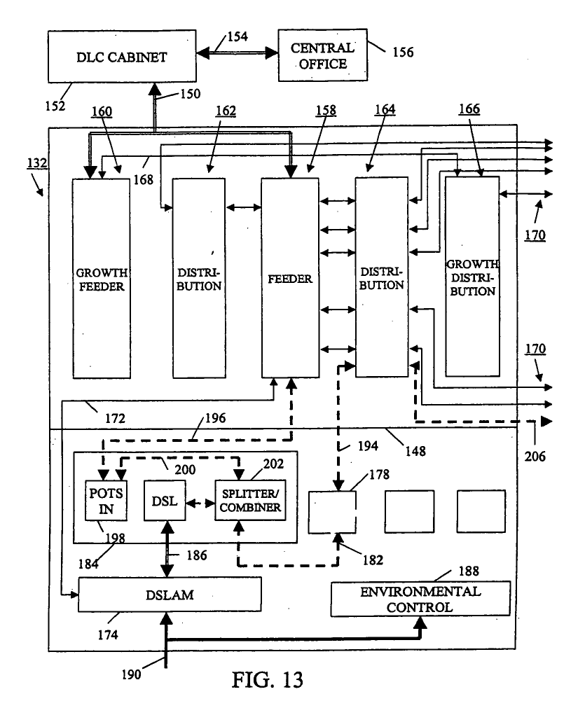

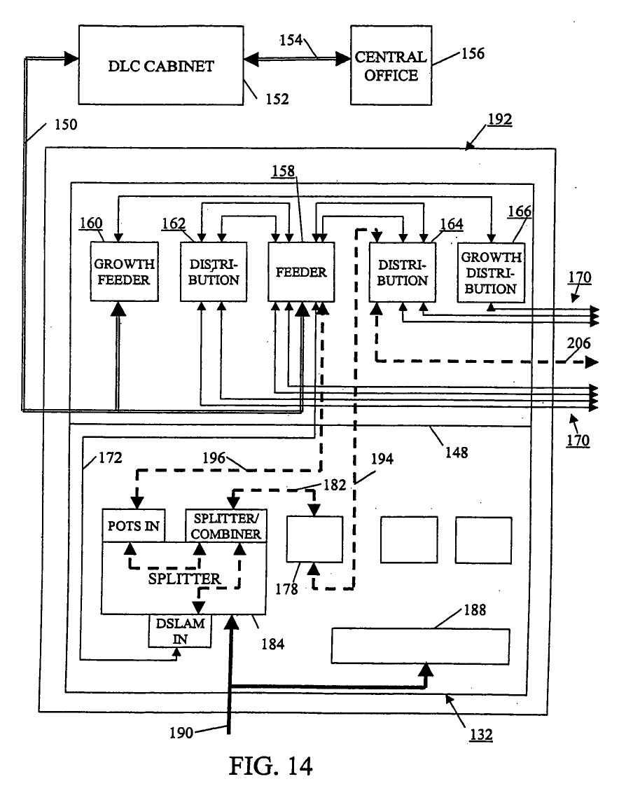

While FIGS. 11 and 12 depict a connection providing a data only DSL transport to a subscriber, FIGS. 13 and 14 show how a connection is made, in the same cabinet, to provide a subscriber with various other DSL transports. Components in FIGS. 13 and 14 bear the same reference numbers as their corresponding components in FIGS. 11 and 12.

In FIGS. 13 and 14, a cross-connect 194, similar to cross-connect 180 in FIGS. 11 and 12, is made between a distribution block in bank 164 and DSL block 178 on the electronics side of the cabinet. In this case, the POTS service that would ordinarily be cross-connected directly between a feeder block and a distribution block in the cross-connect side of the cabinet, is instead routed by a cross-connect 196 to the splitter 184. Within the splitter, 184, as shown in FIG. 13, the POTS service is connected through a “POTS IN” port 198 and a connection 200 to a splitter/combiner 202. The splitter/combiner is, in turn, connected through line 182 to DSL block 178, which is connected to a distribution block in bank 164 by a cross-connect 194, which is directly connected at the distribution block to subscriber line 206. Cross-connects can be provided between the cross-connect and electronics compartments of the cabinet and a gateway or a module with similar capabilities (not shown) can be connected to a portion of the DSLAM 174 to provide DSL transport to multiple subscribers. As in FIGS. 11 and 12, the connections made from one side of the cabinet to the other side in FIGS. 13 and 14 can be made through cables that are relatively short, typically only about three to six feet in length.

Although not specifically illustrated, several variations of DSL transport may be combined in the same cabinet, utilizing connections as depicted in FIGS. 11-14. In the arrangement in FIGS. 13 and 14, for each subscriber to whom DSL transport, for example, is to be provided, two cross-connects must be made from one side of the cabinet to the other.

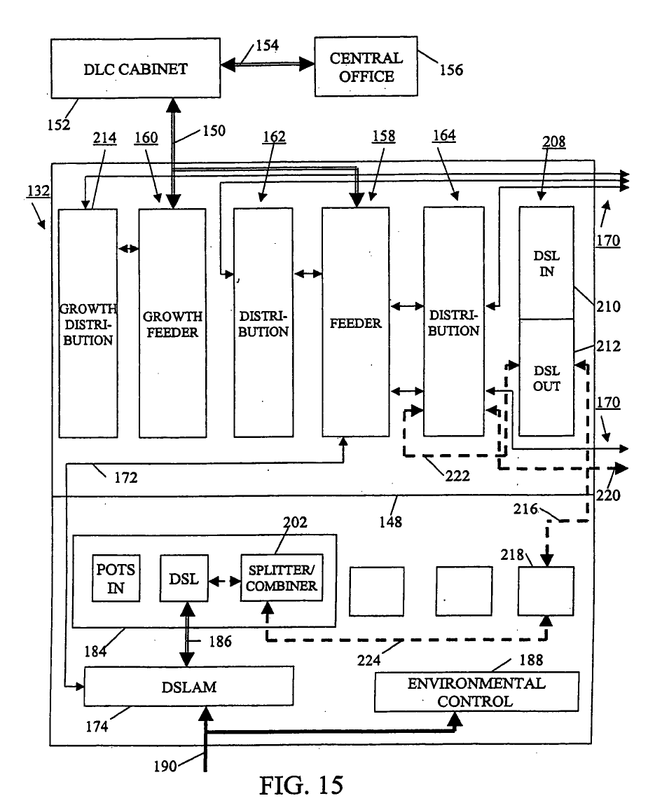

Examples of configurations that avoid the need to make cross-connects from one side of the cabinet to the other side to provide DSL transport are depicted in FIGS. 15-18. In these figures, components that are identical to corresponding components in FIGS. 11-14 bear the same reference numbers.

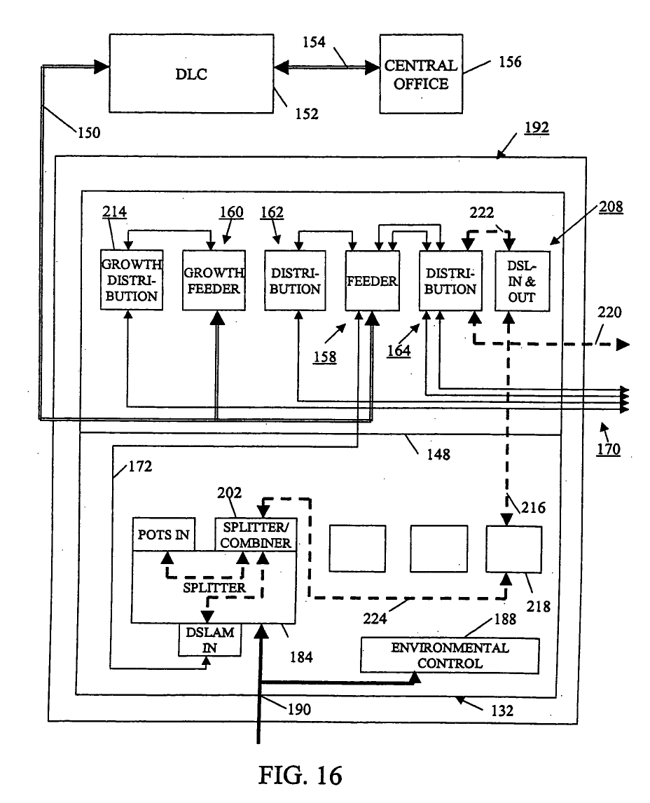

Briefly, the cross-connects between the electronics side and the cross-connect side of the cabinet are avoided by pre-wiring the connections from one side of the cabinet to the other. As shown in FIGS. 15 and 16, a bank 208 of DSL blocks 210 and 212 may be provided at one end of the cabinet, either in addition to, or instead of the bank 166 of growth distribution blocks as shown in FIGS. 11-14. A bank 214 of growth distribution blocks may be provided at the opposite end of the cabinet. Cross-connects are pre-wired between the bank 208 of DSL blocks and the DSL blocks in the electronics side. For simplicity, FIGS. 15 and 16 show only one such pre-wired cross-connect, 216, between block 212 on the cross-connect side, and block 218 on the electronics side.

In practice, a large number of such pre-wired cross-connections from one side of the cabinet to the other will be provided, and may be made using a cable. The DSL blocks in the electronics side of the cabinet are optional, being present for convenience in making the pre-wired connections. They may be eliminated in favor of direct connections between the splitter and the blocks in bank 208 on the cross-connect side of the cabinet.

In FIGS. 15 and 16, a data only DSL transport is provided to a subscriber on line 220 through cross-connect 222, between block 212 (FIG. 15) in bank 208 and a distribution block in bank 164, and through a pre-wired cross-connect 224 between the splitter 184 and DSL block 218 and pre-wired cross-connect 216 between block 218 and block 212 in bank 208. Pre-wired cross-connects corresponding to connection 224 are preferably provided to serve all the subscribers, or at least a large number of subscribers.

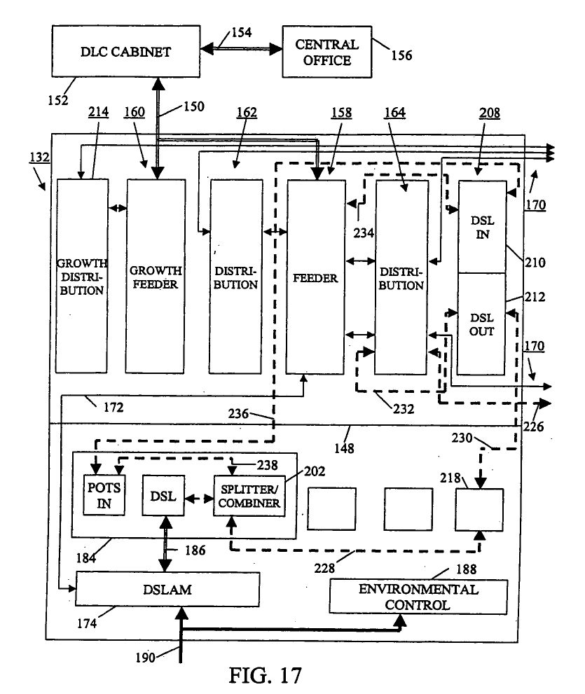

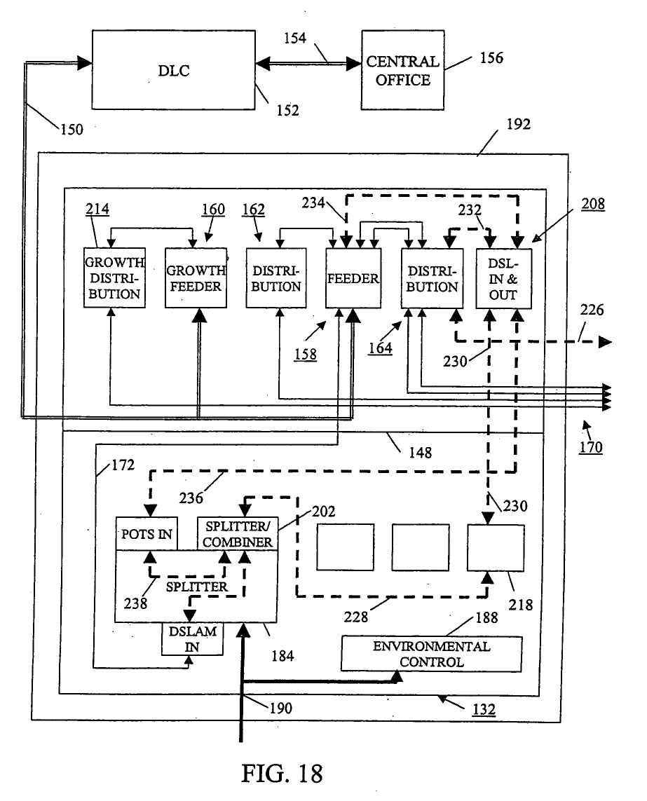

In FIGS. 17 and 18, DSL transports, for example ADSL, are provided to a subscriber on line 226 through a pre-wired cross-connect 228, between the splitter and DSL block 218, a pre-wired cross-connect 230, between block 218 and block 212 (FIG. 17) in bank 208, and through a cross-connect 232, between block 212 in bank 208 and a distribution block in bank 164. POTS service for the subscriber on line 226 is routed through a feeder block in bank 158, and cross-connect 234, to DSL block 210, which is pre-wired to the splitter 184 through connection 236. A pre-wired cross-connect is also made at the splitter through connection 238 so that the subscriber's voice service can be combined in the splitter with the subscriber's DSL transport in the splitter/combiner 202. Here again, numerous cross-connects corresponding to cross-connects 232 and 234, may be made, depending on the number of subscribers. Cross-connect 236 is preferably pre-wired to provide DSL transport to all of the subscriber lines or at least to a large number of them. Connection 238 is an internal connection in the splitter. In the same cabinet, some subscribers can be provided with, for example, a data only DSL transport, and others can be provided with a DSL transport, using connections as illustrated by FIGS. 15-18.

Whenever a subscriber served by the cross-connect cabinet of FIGS. 15-18 requests DSL transport, the service can be provided by making cross-connects at readily accessible terminals on the cross-connect side of the cabinet.

In summary, the invention provides for the increased availability of DSL transport to subscribers further away from the network, by locating the DSLAM equipment at the site of a Cross-Connect Cabinet and/or at remote parts of the network. DSL transport can be provided to subscribers, instead of only to such subscribers serviced directly by a Central Office or other location at which DSLAM equipment is provided. Moreover, by bringing the electronic equipment closer to the subscribers, the invention improves the data speed provided to those subscribers.

The incorporation of the DSLAM and related electronic equipment in the same cabinet with the cross-connect blocks avoids the problems associated with real estate acquisition and approvals. It also avoids crosstalk, and cable capacity limitations resulting from crosstalk by locating the DSL equipment, and interjecting the DSL signal, at the distribution interface. With pre-wired connections between the cross-connect side and the electronic side of the cabinet, the connections required to provide DSL transport to subscribers can be readily made without feeding wires from one side of the cabinet to the other. The ability to provide DSL transport without having to disturb equipment that provides voice service (such as cabling, electronics, etc.) affords significant financial advantages to the telephone company.

By providing a controlled environment for the electronic equipment, the invention affords the telephone company the option of using relatively inexpensive electronic components. The invention allows various DSL transports to be provided to subscribers served by the Cross-Connect Cabinet. The invention also provides for simple and rapid retrofitting of a Cross-Connect Cabinet for DSL transport, and for expansion of conventional telephone service at the same time that DSL transport is installed. Additionally, the invention further allows a phone company to continue to use its automated loop testing system to test its copper pairs because the copper infrastructure to the remote cabinet feeder side is untouched.

FIGS. 11-18 depict typical installations in accordance with the invention, but advantage may be taken of the principles of the invention in many other configurations. For example, the number and layout of the cross-connect blocks can be varied in innumerable ways, the splitter circuitry and the DSLAM can be combined as a single unit, as can other disclosed elements, and the array of blocks on the electronic side of the cabinet can also be varied, or eliminated altogether by making direction connections between the splitter and the cross-connect side of the cabinet. The front and rear sides of the cabinet can be separately lockable so that an individual having access to one side can be denied access to the other side. Although retrofitting is preferably carried out by removing an existing cabinet enclosure, retaining the existing cross-connect block fields and their connections, and adding DSLAM electronic equipment and, optionally, additional block fields, some or all of the cross-connect block fields can also be replaced. Cable splicing techniques in which interruption of service is avoided can be used when cross-connect block fields are replaced. In the case of retrofitting an existing cabinet having cross-connect fields on both sides, the DSLAM and splitter can be located adjacent to one end of the cross-connect fields, and growth blocks and/or additional blocks for pre-wired connections between the splitter and the feeder and distribution blocks can be located either adjacent to the DSLAM and splitter or adjacent the other end of the cross-connect fields. Alternatively, some or all of the added components, such as the DSLAM, splitter, and other equipment, can be located in one or more compartments provided on top or to the side of the cabinet. Various combinations of possible configurations for the location of added components will be apparent to persons skilled in the art after having read and understood the above description.

It is anticipated that most installations made in accordance with the invention will be retrofitted Cross-Connect Cabinets, in which existing cross-connect block fields will remain in place, while the cabinet is wholly or partially replaced, and DSL electronic equipment and additional cross-connect blocks are added. However, in some cases, rehabilitation will be carried out, in which case most or all feeder and distribution blocks will be replaced at the time the cabinet is wholly or partially replaced and DSL equipment is added. Rehabilitation can be carried out without interruption of service, by utilizing known techniques for by-passing the cross-connects.

The following discussion centers around various other concepts and modifications that are related to the apparatus and method of the present invention.

Indoor Building Entrance Terminal (BET)

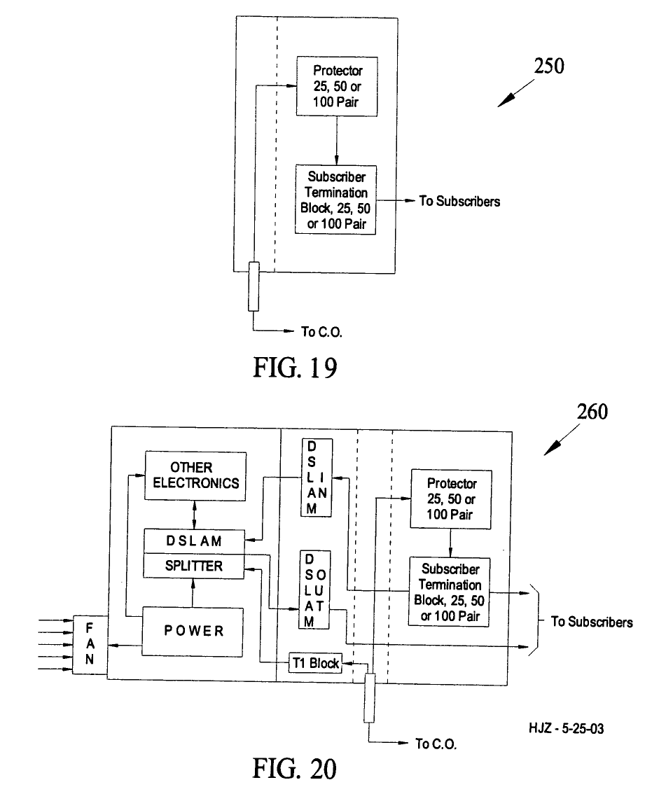

A BET can be considered as a specialized cross-connect cabinet. An indoor BET is located in an interior of a location such as an apartment complex, multi-tenant commercial building, etc. With the deployment of DSLAMs to existing telecommunication SAI sites, broadband services can be provided as previously described. However, instead of providing such services to SAI sites, they could be provided to a termination point such as an indoor BET 250. Typically, when telephone service is brought to such a location and before each subscriber is physically configured, the cable providing this service is terminated indoors in a closet or basement on what is known as the indoor BET. Such a BET is usually comprised of a housing having an enclosed, lockable chamber where the incoming cable is terminated. Prior to the conductors being connected to the individual subscribers, they are first connected to protectors or fuses, via thin gauge (fuse link) conductors. These protectors mitigate any voltage transients and/or lightening surges before they could reach the subscriber's equipment. Outgoing termination means are also provided to finally connect the subscriber's conductors. BETs are usually provided in 25, 50 or 100 pair sizes to reflect the number of subscriber lines being terminated as depicted in FIG. 19.

Referring now to FIG. 20, a means to bring DSL transport and various services to be carried via the transport to an indoor multi-subscriber location using an existing BET location, cable feeding this location, using existing protector and terminating blocks and adding to them a new enclosure 260 is depicted. This enclosure will not only house this equipment, but will also house additional equipment such as cross-connect equipment and a DSLAM for example.

Referring further to FIG. 20, the enclosure or system is a wall, rack or floor mountable enclosure preferably comprising two distinct and separate partitions. It should be noted that no partitions may be needed when housing the various components of the enclosure. A first side or cross-connect side houses the termination entry point of the existing incoming cable, protector block(s), and subscriber termination block(s). In addition, the first side would house DSLAM IN and DSLAM OUT termination block fields. A second side, or electronic side, would house the DSLAMs, splitters, rectifiers, incoming power, etc. Both sides would be lockable depending on security and craft separation concerns.

Although this system is an indoor installation, the electronic side includes temperature sensing and controlling means and can be cooled via forced air convection, while the cross-connect side requires no cooling, just venting. Both sides, however, meet all applicable EMI/RFI standards.

In the case of a T1 feed, two T1 pairs are chosen from spare pairs in the cable and connected to the T1 block in the first side which in turn is connected to the DSLAM in the second side. As a subscriber chooses to obtain DSL services via a DSL transport, the subscriber's pair is disconnected from the termination block and connected to the DSLAM OUT block. A new pair of wires then takes their place on the termination block and connects to the DSLAM IN block. In addition to providing data only DSL transport to a subscriber, both voice and data may be provided, where the related service is provided through a splitter before exiting via the DSLAM OUT block.

Various cabinet control concepts and cabinet security concepts may be utilized with such a BET system as described further herein.

Outdoor Building Entrance Terminal (BET)

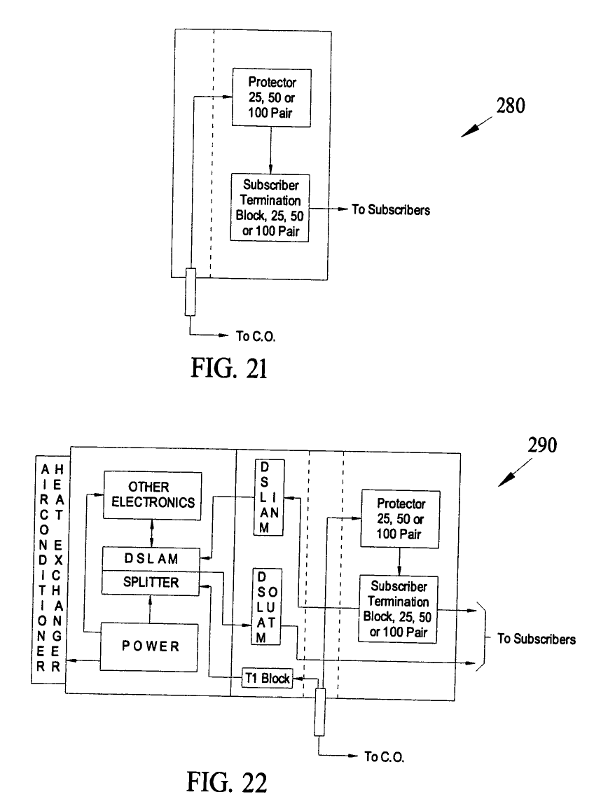

The outdoor BET is similar to the indoor BET with a few exceptions. For example, an outdoor BET is located on an exterior of a location such as an apartment complex, multi-tenant commercial building, etc. With the deployment of DSLAMs to existing telecommunication SAI sites, broadband services can be provided as previously described. However, instead of providing such services to SAI sites, they could be provided to a_TELCO/Subscriber handoff that is on the exterior of a location. Typically, when telephone service is brought to such a location and before each subscriber is physically configured, the cable providing this service is terminated outdoors on a wall in what is known as an outdoor BET. Such a BET 280 is usually comprised of a weatherproof housing having an enclosed, lockable chamber where the incoming cable is terminated. Prior to the conductors being connected to the individual subscribers, they are first connected to protectors or fuses, via thin gauge (fuse link) conductors. These protectors mitigate any voltage transients and/or lightening surges before they could reach the subscriber's equipment. Outgoing termination means are also provided to finally connect the subscriber's conductors. BETs are usually provided in 25, 50 or 100 pair sizes to reflect the number of subscriber lines being terminated as depicted in FIG. 21.

Referring now to FIG. 22, a means to bring DSL transport and various services to be carried via the transport to an outdoor multi-subscriber location using the existing BET location, cable feeding this location, using existing protector and terminating blocks and adding to them a new enclosure 290 is depicted. This enclosure will not only house this equipment, but will also house additional equipment such as cross-connect equipment and a DSLAM for example.

Referring further to FIG. 22, the enclosure or system is a wall-mountable outdoor enclosure preferably comprising two distinct and separate partitions. It should be noted that no partitions may be needed when housing the various components of the enclosure. A first side or cross-connect side houses the termination entry point of the existing incoming cable, protector block(s), and subscriber termination block(s). In addition, the first side would house DSLAM IN and DSLAM OUT termination block fields. A second side, or electronic side, would house the DSLAMs, splitters, rectifiers, incoming power, etc. Both sides would be lockable depending on security and craft separation concerns.

The electronic side meets Telcordia GR-487 standards and has temperature sensing and controlling means and can be cooled via heat exchangers or air conditioning, while the cross-connect side would require no cooling, just venting. Both sides, however, would meet all applicable EMI/RFI standards.

In the case of a T1 feed, two T1 pairs are chosen from spare pairs in the cable and connected to the T1 block in the first side which in turn is connected to the DSLAM in the second side. As a subscriber chooses to obtain DSL services via a DSL transport, the subscriber's pair is disconnected from the termination block and connected to the DSLAM OUT block. A new pair of wires then takes their place on the termination block and connects to the DSLAM IN block. In addition to providing data only DSL transport to a subscriber, both voice and data may be provided, where the related service is provided through a splitter before exiting via the DSLAM OUT block.

Various cabinet control concepts and cabinet security concepts may be utilized with such a BET system as described further herein.

Outdoor Aerial Terminal

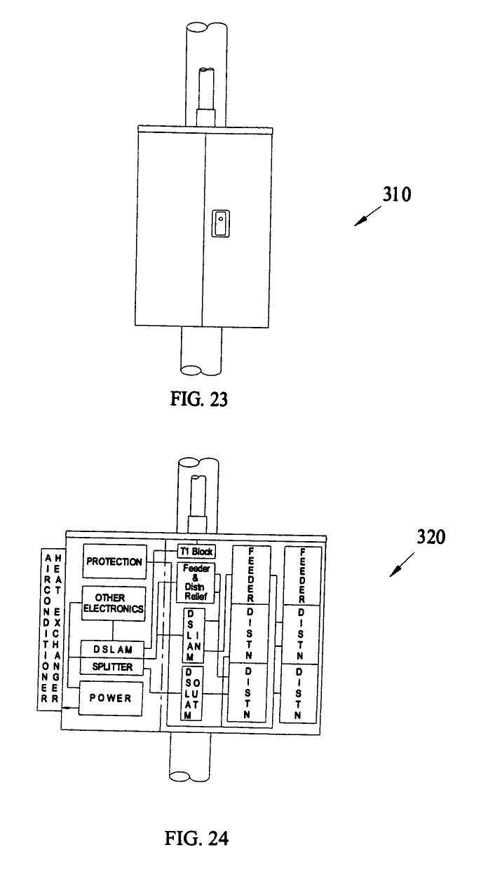

With the deployment of DSLAMs to existing telecommunication SAI sites, broadband services can be provided as previously described. However, instead of providing such services to a pad mounted SAI site, they could be provided to an Outdoor Aerial Terminal 310. When it is difficult or costly to bury telephone cables in the ground, they are often strung on poles on their way from the central office to the subscriber. In addition, even when buried cable is being used, real estate may not be available to construct a pad or, the area may be in a flood plain. When it becomes necessary to access the cable in both of these instances, to make connections (cross-connect) to specific subscribers, or to change the cable assignments, an Aerial Terminal is used as depicted in FIG. 23. The terminals are typically equipped with a stub cable which can exit either from the top or the bottom of the terminal. This stub is then spliced into the main cable and encased in an aerial or buried splice case. The cabinets can be mounted on various objects such as regular poles, stub poles or walls.

Referring now to FIG. 24, a means to bring DSL transport and various services to be carried via the transport to these locations over the existing copper plant using an existing Aerial Terminal location, cable feeding this location, using existing protector and terminating blocks and adding to them a new enclosure 320 is depicted.

Referring further to FIG. 24, the enclosure or system is a pole/wall-mountable outdoor enclosure preferably comprising two distinct and separate partitions. It should be noted that no partitions may be needed when housing the various components of the enclosure, and that these partitions could also be on opposite sides of the pole from each other, on all four sides of the pole, or above and below each other to maintain equal loading on the pole.

A first side or cross-connect side houses the termination entry point of the existing incoming cable and further houses the feeder and distribution pairs, as well as, relief pairs, DSLAM IN and DSLAM OUT termination block fields. A second side, or electronic side, would house the DSLAMs, splitters, rectifiers, incoming power, protector block fields, etc. Both sides would be lockable depending on security and craft separation concerns.

The electronic side meets Telcordia GR-487 standards and has temperature sensing and controlling means and can be cooled via heat exchangers or air conditioning, while the cross-connect side would require no cooling, just venting. Both sides, however, would meet all applicable EMI/RFI standards. Data only DSL through pairs, for example, would be wired in the same manner as previously described.

Cabinet Control Center

The internal environment of the systems and cabinets described in the present invention, contain sensitive electronic equipment, and are relatively stable and maintained within rather narrow boundaries in order to function properly. Furthermore, greater security concerns arise when valuable revenue generating equipment is unduly susceptible to vandalism or exposed to unauthorized intrusion. Even though various standards exist for outdoor electronic cabinets (e.g. Telcordia GR-487-CORE which outlines the minimum physical parameters a telecommunications cabinet must meet, and GR-27, which outlines requirements for environmental control systems for Controlled Environmental Vaults (CEVs), Huts and Walk-In Cabinets), no specific requirements exist for cabinets and systems described herein.

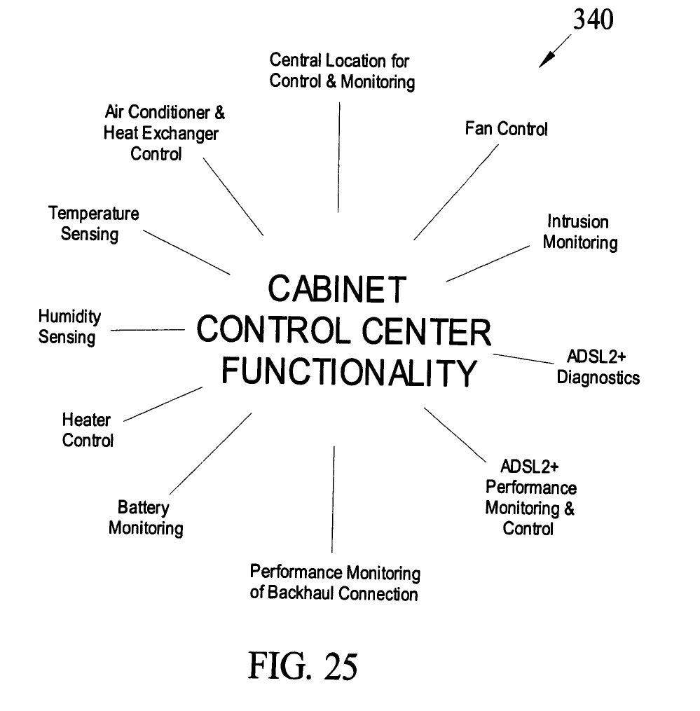

What is needed therefore, is to centralize the monitoring and control of such cabinets and systems and the network elements they contain in a common hardware/software functional element. The Cabinet Control Center functionality 340, depicted in FIG. 25, has three functional blocks: 1) Monitoring and Measuring; 2) Logic; 3) Communications and Control.

The Monitoring and Measuring functional block gathers information relating to the cabinet's environment and security. Examples are: internal temperature, internal humidity, AC power, DC power, airflow and/or fan operation, intrusion alarms, high-water, heater function, self-test, etc. The Monitoring and Measuring functional block may also be used gather information about cabinet inputs/outputs. Examples would be monitoring BER on the transmission link to the network; and, performing loop/line testing on the DSLs radiating from the cabinet.

The Cabinet Control Center's Logic functional block can be programmed with performance thresholds associated with the various parameters being monitored/measured and, further, programmed with a set of appropriate responses and/or status indications to be communicated to a central location. An example would be: “If the internal cabinet temperature rises above 65 C, turn on the fans.” Another would be: “If the cabinet door is opened and the intrusion alarm is not manually silenced within 30 seconds, communicate an intrusion warning to a central location.”

The Communication/Control functional block is capable of communicating required information upstream to a central location. It is also capable of accepting commands communicated downstream from the central location and acting on them accordingly. The communications channel could be a dial-up or dedicated data link. Or, preferably, the communications between the Cabinet Control Center and the central location will be in packet format (i.e. IP). The communications protocol is preferably a standard one such as CORBA, and the internal communications inside the cabinet should, ideally, be Ethernet.

The individual electronics contained in the systems and cabinets of the present invention each have their own thermal requirements which must be monitored and maintained. For economic reasons, not all of the electronics are initially installed. As more subscribers are added, more electronics are added. As such, it would be desirous to expand the monitoring capability as well.

Further described, the Cabinet Control Center is capable of remotely programming, monitoring and controlling the systems and cabinets described in the present invention as well as any other similar system and cabinet. The Cabinet Control Center is preferably microprocessor controlled and programmable for each DSLAM manufacturer's product and for the criteria described below.

Such criteria includes controlling the internal cabinet temperature and humidity by means of sensors which activate heaters, fans, heat exchangers, or air conditioners, alone or in tandem, to regulate the internal cabinet environment This is accomplished, for example, in a modular fashion so as to increase the cooling/heating capability as the electronics are increased. Other criteria include monitoring cabinet intrusion regarding date, time and type of worker code (i.e. splicer, technician, etc.) and transmitting alarm conditions. Such functionality is preferably remotely addressable from a central location such as the Central Office. Further criteria include, monitoring the battery life remotely, real time, or by alarm signals when preset battery life parameters are compromised, accessing ADSL2+ or comparable electronic chip sets (which include diagnostic capabilities that may provide a broadband testing capability at the cabinet if it were feasible to do so) remotely or within the cabinet and performing line and broadband testing, accessing, either on a continuous basis or on command from a central location, the ADSL2+ or comparable electronic chip sets for performance monitoring and control, and for performance monitoring and control of a backhaul connection, and providing bi-directional communications between the remote cabinet and a central location for the purposes described above. The communications link may be either a modem connection on a copper pair in the feeder cable connecting the cabinet to the CO or a packet-format communications channel in the backhaul connection to the CO.

Cabinet Security

Currently, the tool of choice and to a large degree, the only locking concept prevalent in the Telephone Outside Plant world is known as the 216 tool, or can wrench, as it has become known. This tool comprises a smaller outside diameter than standard hex socket wrenches which would allow it to access the hex bolt. Larger outside diameters would not fit and, hence, could not turn the hex bolt. “Cupped Sems” and other locks using this principle formed the basis of securing most telco housings, pedestals cabinets and enclosures to prevent unauthorized entry. Needle nose pliers, comparable diameter sockets, even a dime coin, could be used to circumvent the required can wrench. Although other security locks using keys or “Penta” type bolts can be used, the ever increasing migration of electronics into the outside plant requires that new, more robust and foolproof methods of protecting this equipment be employed. Not only can unlawful entry to these enclosures, where electronics reside, cause product or system failure, but significant revenue could be lost when the equipment is inactive, due to inadvertent tampering or vandalism.

Thus, a device and method comprising hardware, software, or a combination of hardware and software, to prohibit unauthorized entry into electronic housings, cabinets and enclosures is needed. This device removes the security concerns associated with deploying DSL transports and services via the systems and cabinets of the present invention to existing cross-connect and terminating facilities such as SAIs or indoor or outdoor Building Entrance Terminals. The cabinet security device or locking device is preferably a two or three point lock, electronically, magnetically or via a combination is push button actuated, either at the cabinet location or remotely, by a programmable device or dynamic instruction. The device's security code could be changed at the cabinet or remotely in the Central Office, for example, by a computer, sent via the internet and through a cell phone, and be downloaded to an actuating device which indirectly or directly opens the cabinet. The locking device can interface electronically to inform a location such as a Central Office when it has been opened or closed, is a device that is preferably flush with the surface it is mounted to, and is constructed in a robust manner utilizing non-flammable and non-corroding materials.

The cabinet security device preferably provides functionality similar to works in conjunction with the Environmental Control Systems inputs, outputs, and alarms as described in GR-27-CORE. Such inputs may include AC power, external temperature sensor, internal temperature sensor, ventilation airflow sensor, relative humidity sensor, toxic/explosive gas monitor, smoke detector, intrusion switch, and high water switch. Such outputs may include air conditioner(s), heater(s), dehumidifier, ventilation blower(s), and an outdoor air damper. Alarms may include high temperature, low temperature, smoke, ventilation, intrusion, ECS malfunction, AC power off, high water and CEV status indicator.

Further features of the cabinet security device include a manually locking mechanism that can be overridden, a flush lock (when the doors of the cabinet are closed, the lock is flush and inaccessible) that may be actuated (“popped-out”), locked, or unlocked based on a received code, for example, and may become accessible when actuated (remotely or manually at the site). The doors may automatically open and shut, but may have to be drawn closed. Software monitors the security device and other devices within the cabinet. For example, an alarm can be sent if a timer expires after the lock has been opened.

Once the lock pops out, the 216 tool can be used by a craftsman, for example, to turn the lock or a portion of the lock in a certain direction. An acknowledgement can then be sent to a test center, for example, that sends a signal to turn an alarm off. Once the craftsman is alerted to the fact that the alarm is off, can complete the turning of the lock or a portion of the lock in the direction and can then open the cabinet doors or covering. Once the doors are shut, the alarm is turned back on and the lock is automatically placed in a flush position. The lock may be manually placed in the flush position and the alarm can be turned on at that point. The information, signals, or messages can be sent and received by the cabinet via the Cabinet Control Center, for example.

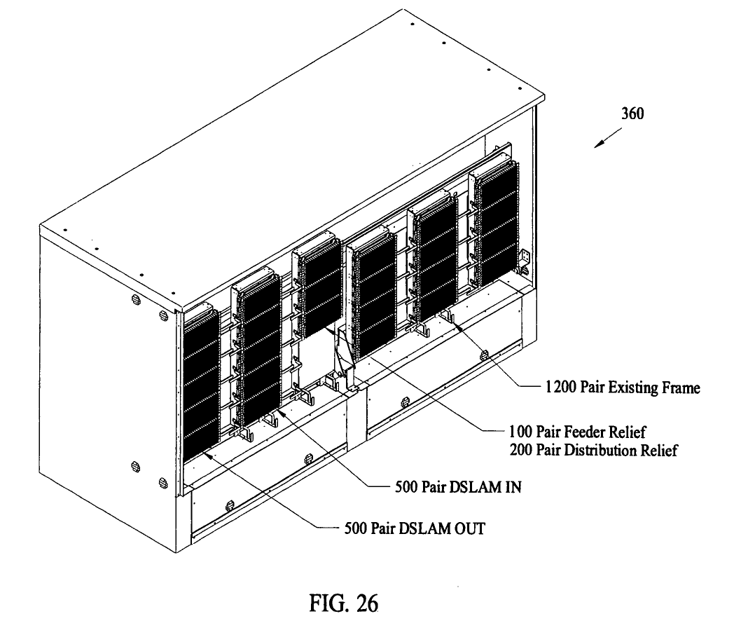

Referring now to FIG. 26, a 1200 pair cabinet 360 of the present invention is depicted on a cross-connect side.

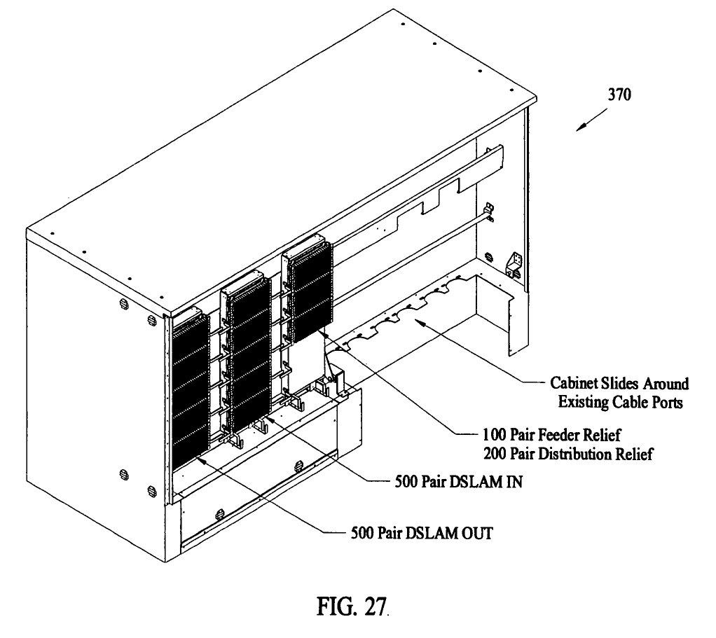

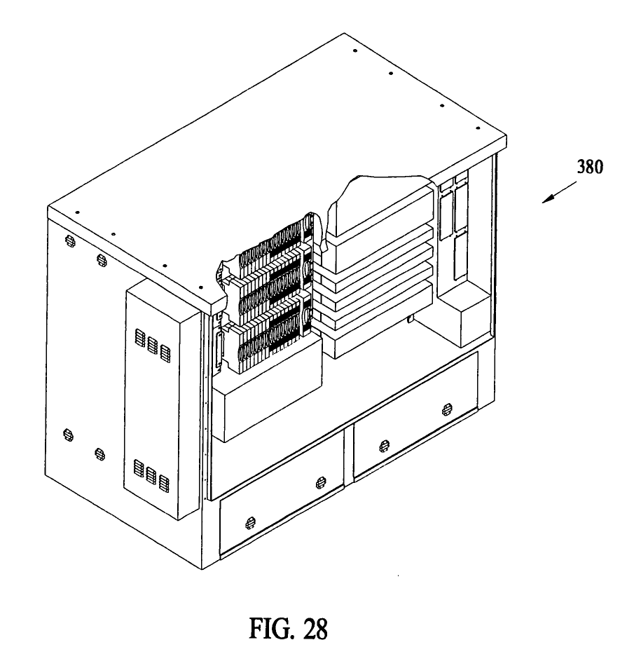

Referring now to FIG. 27, a 1200 pair cabinet 370 of the present invention is depicted on a cross-connect side.

Referring now to FIG. 28, a 1200 pair cabinet 380 of the present invention is depicted on an electronic side with, for example, an installed 240 port IP DSLAM.

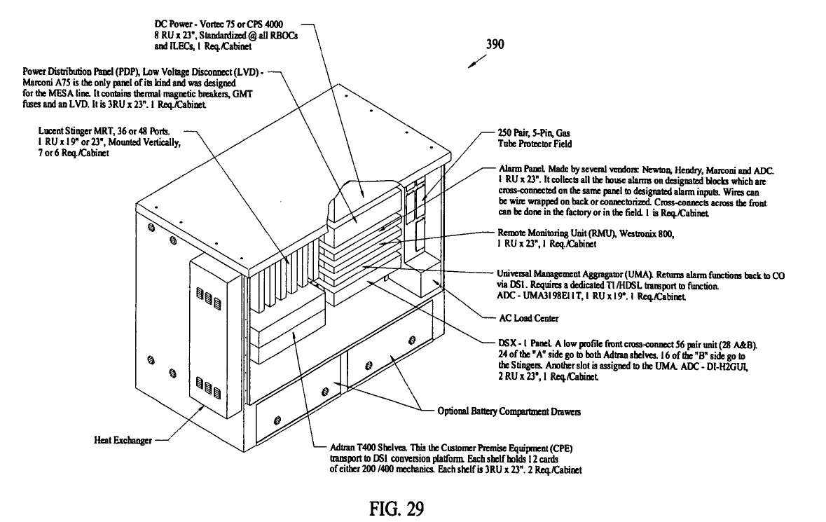

Referring now to FIG. 29, a 1200 pair cabinet 390 of the present invention is depicted on an electronic side with, for example, an installed 250 port MRT.

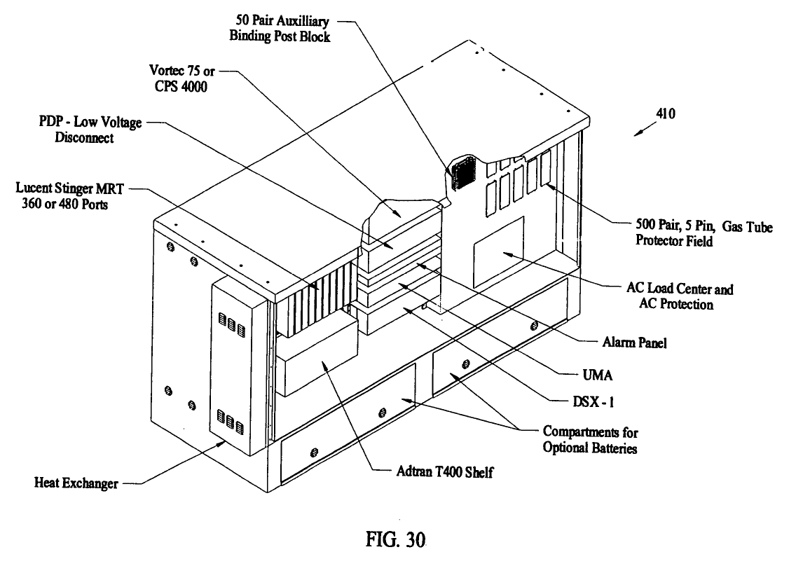

Referring now to FIG. 30, a 1200 pair cabinet 410 of the present invention is depicted on an electronic side with, for example, an installed MRT.

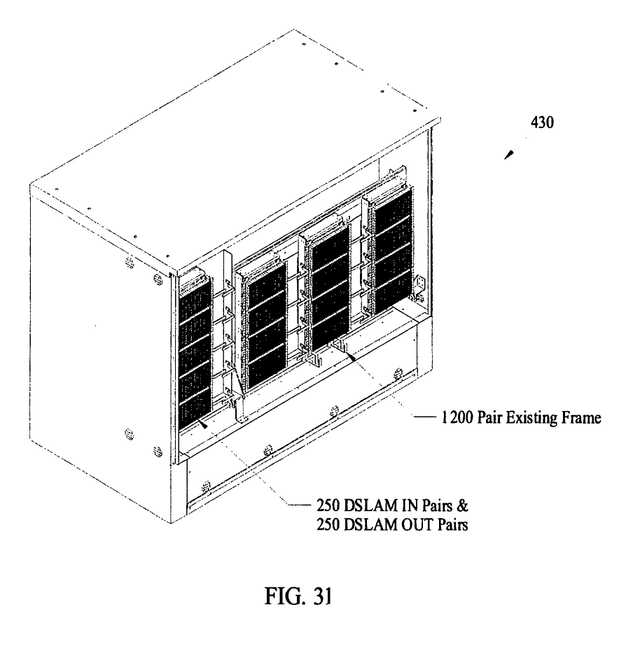

Referring now to FIG. 31, a 1200 pair cabinet 430 of the present invention is depicted on a cross-connect side with, for example, an installed binding post frame.

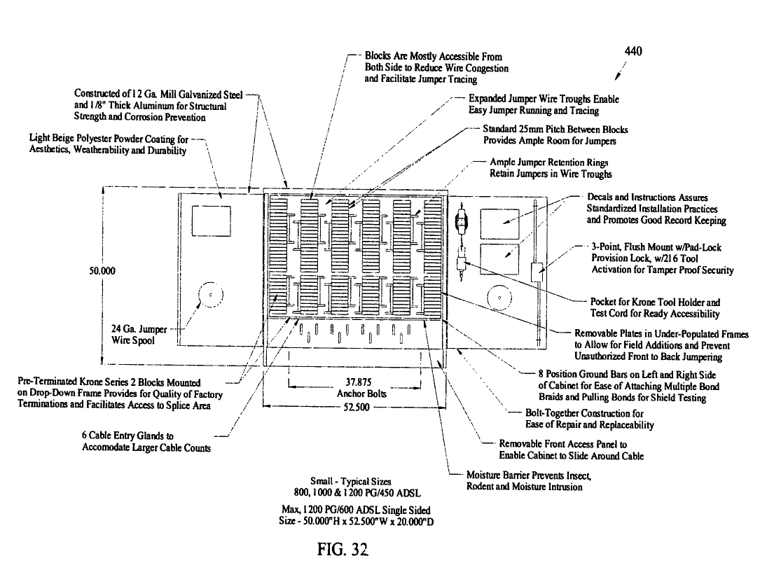

Referring now to FIG. 32, a small cabinet 440 adapted to provide ADSL functionality, for example, of the present invention is depicted.

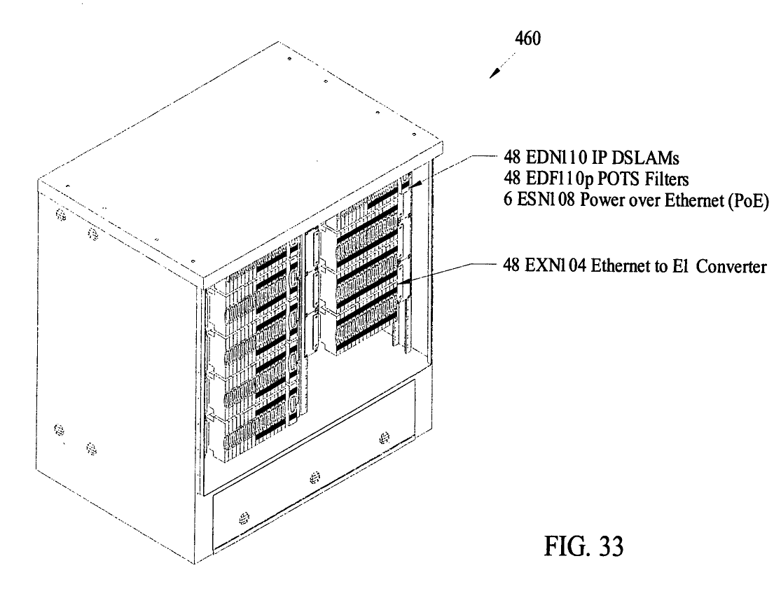

Referring now to FIG. 33, a 1200 pair cabinet 460 adapted to provide ADSL functionality, for example, of the present invention is depicted. 480 port IP DSLAMs are installed in a back side of the cabinet (which is shown with it's doors removed). It should be noted that the heat exchanger is preferably coupled to or integrated with one or more of the doors.

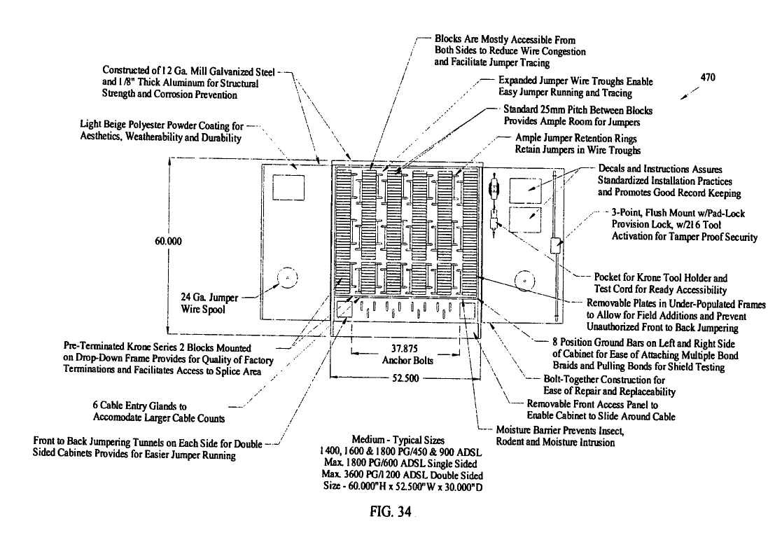

Referring now to FIG. 34, a medium cabinet 470 adapted to provide ADSL functionality, for example, of the present invention is depicted.

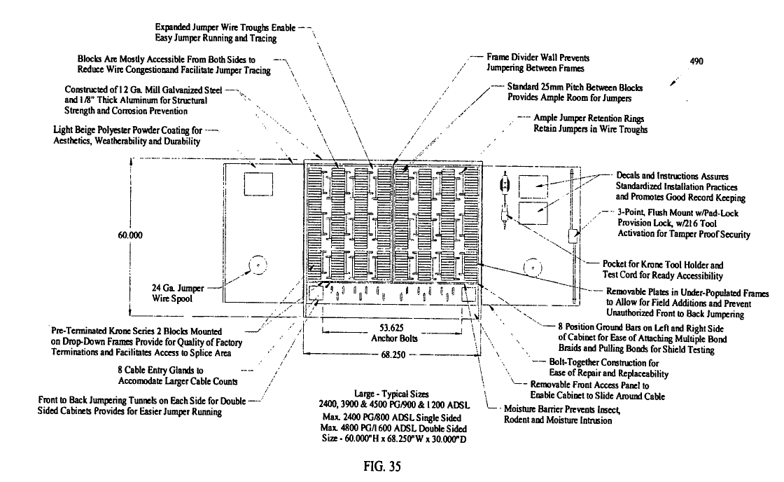

Referring now to FIG. 35, a large cabinet 490 adapted to provide ADSL functionality, for example, of the present invention is depicted.

The present invention discloses a series of high-performance outdoor environmental enclosures and products to enable telephone companies to augment their access network infrastructures with the active network elements required for ubiquitous, high-quality broadband services. Some of these products will convert existing SAICs to environmentally-controlled enclosures capable of hosting active electronics network elements. Other products will be free-standing cabinets to be co-located with already existing, older-generation DLC cabinets to host similar active electronics network elements and sharing the distribution cable facilities that radiate from the existing cabinets. In either case, active electronics network elements (i.e. DSLAMs) and their supporting equipment are introduced into physical locations not intended or designed to accept them. The creation, monitoring and controlling of enclosures which establish the hospitable environment for this equipment, with maximum utilization and minimum disruption of the telcos' existing infrastructure are achieved by the present invention.

Still other modifications may be made to the apparatus and method described above without departing from the scope of the invention as defined in the following claims.

We claim:

1. A method for providing high speed, digital telecommunications service from a site of an existing telecommunications serving area interface comprising a first enclosure wherein subscriber lines are cross-connected to a telecommunications trunk to provide voice telecommunications services to subscribers through said subscriber lines, the method comprising the steps of:
providing an enlarged enclosure at the site of said first enclosure;
incorporating into said enlarged enclosure, along with feeder and distribution blocks, a broadband electronic multiplexer connected to a provider through a high-speed interface; and
connecting said multiplexer through plural data connections to said distribution blocks, thereby providing high speed, digital telecommunications service at least to selected ones of said subscribers.

2. A method for providing digital subscriber line service from a site of an existing telecommunications serving area interface comprising a first enclosure wherein subscriber lines are cross-connected to a telecommunications trunk to provide voice telecommunications services to subscribers through said subscriber lines, the method comprising the steps of:
providing an enlarged enclosure at the site of said first enclosure;
incorporating into said enlarged enclosure, along with feeder and distribution blocks, a digital subscriber line access multiplexer connected to a digital subscriber line provider through a high-speed interface; and
connecting said digital subscriber line access multiplexer through plural data connections to said distribution blocks, thereby providing digital subscriber line service at least to selected ones of said subscribers.

3. A method of retrofitting a telecommunications serving area interface comprising an enclosure, and feeder and distribution blocks within said enclosure, the distribution blocks being connected to a plurality of subscribers through subscriber lines, the feeder blocks being connected to a telecommunications trunk, and the feeder and distribution blocks being cross-connected to provide voice telecommunications services to said subscribers, the method comprising the steps of:
providing an enlarged enclosure containing said feeder and distribution blocks;
incorporating into said enlarged enclosure, along with said feeder and distribution blocks, a digital subscriber line access multiplexer connected to a digital subscriber line provider through a high-speed interface; and
connecting said digital subscriber line access multiplexer through plural data connections to said distribution blocks for providing digital subscriber line service at least to selected ones of said subscribers.

4. The method according to claim 3, wherein the step of incorporating a digital subscriber line access multiplexer into said enlarged enclosure includes the step of incorporating additional distribution blocks into said enlarged enclosure.

5. The method according to claim 3, wherein the step of incorporating a digital subscriber line access multiplexer into said enlarged enclosure includes the step of incorporating additional feeder blocks into said enlarged enclosure.

6. The method according to claim 3, wherein the step of incorporating a digital subscriber line access multiplexer into said enlarged enclosure includes the step of incorporating additional distribution and feeder blocks into said enlarged enclosure.

7. A method of retrofitting a conventional telecommunications serving area interface to incorporate digital subscriber line service comprising removing an existing cross-connect cabinet, and substituting for the removed cabinet a new cross-connect cabinet the interior of which contains two compartments, one compartment containing feeder and distribution blocks, and the other of the two compartments containing a digital subscriber line access multiplexer and a splitter connected to said access multiplexer, and providing interconnections between the splitter in said other compartment and the feeder and distribution blocks in the one compartment.

8. A telecommunications interface comprising:
an enclosure;
feeder and distribution blocks within said enclosure, the distribution blocks being connected to a plurality of subscribers through subscriber lines, the feeder blocks being connected to a telecommunications trunk, and the feeder and distribution blocks being cross-connected to provide voice telecommunications services to said subscribers; and
a broadband electronic multiplexer connected to a provider through a high-speed interface, and being connected through plural data connections to said distribution blocks for providing high speed, digital telecommunications service at least to selected ones of said subscribers;
wherein the multiplexer is also located within said enclosure along with said feeder and distribution blocks.

9. A telecommunications interface comprising:
an enclosure;
feeder and distribution blocks within said enclosure, the distribution blocks being connected to a plurality of subscribers through subscriber lines, the feeder blocks being connected to a telecommunications trunk, and the feeder and distribution blocks being cross-connected to provide voice telecommunications services to said subscribers; and
a digital subscriber line access multiplexer connected to a digital subscriber line provider through a high-speed interface, and being connected through plural data connections to said distribution blocks for providing digital subscriber line service at least to selected ones of said subscribers.

10. The telecommunications interface according to claim 9 wherein the digital subscriber line access multiplexer is also located within said enclosure along with said feeder and distribution blocks.

11. The telecommunications interface according to claim 9, including a splitter within said enclosure, wherein the digital subscriber line access multiplexer is connected to the splitter, and wherein at least selected terminals of the feeder blocks are also connected to the splitter.

12. The telecommunications interface according to claim 11 wherein said plural data connections to said distribution blocks are constituted by connections from the splitter to the distribution blocks, whereby selected subscribers connected to said distribution blocks are provided with both voice and digital subscriber line service over the same subscriber lines.

13. The telecommunications interface according to claim 9, in which the enclosure is divided into plural, separate compartments, a first of said compartments containing said feeder and distribution blocks, and a second of said compartments containing said digital subscriber line access multiplexer.

14. The telecommunications interface according to claim 13 wherein said blocks being accessible for cross-connection through an opening in the enclosure through which the multiplexer is not accessible, and said multiplexer being accessible through an opening in said enclosure through which said blocks are not accessible for cross-connection, in which said plural data connections extend from the first compartment to the second compartment.

15. The telecommunications interface according to claim 14, whereby digital subscriber line service can be provided to subscribers by cross-connections made solely in said first compartment.

16. The telecommunications interface according to claim 9, in which the enclosure is divided into plural compartments containing at least one of a following element from a list comprising:
said feeder and distribution blocks; and
said digital subscriber line access multiplexer.

17. The telecommunications interface according to claim 16 wherein said blocks being accessible for cross-connection through an opening in the enclosure through which the multiplexer is not accessible, and said multiplexer being accessible through an opening in said enclosure through which said blocks are not accessible for cross-connection, in which said plural data connections extend from the first compartment to the second compartment.

18. The telecommunications interface according to claim 17, wherein the number of said plural connections exceeds the number of said selected ones of said subscribers, whereby digital subscriber line service can be provided to additional subscribers by cross-connections made solely in said first compartment.

19. The telecommunications interface according to claim 16, in which said compartments are separately lockable, whereby access to one compartment can be denied to an individual worker who is permitted access to the other compartment.

20. A telecommunications interface comprising:
a splitter within an enclosure, wherein the digital subscriber line access multiplexer is connected to the splitter, wherein at least selected terminals of feeder blocks are also connected to the splitter, wherein plural data connections to distribution blocks are constituted by connections from the splitter to the distribution blocks whereby selected subscribers connected to said distribution blocks are provided with both voice and digital subscriber line service over the same subscriber lines, and in which the enclosure is divided into plural, separate compartments, a first of said compartments containing said feeder and distribution blocks, and a second of said compartments containing said digital subscriber line access multiplexer and said splitter.

21. The telecommunications interface according to claim 20, wherein said blocks being accessible for cross-connection through an opening in the enclosure through which the multiplexer and splitter are not accessible, and said multiplexer and splitter being accessible through an opening in said enclosure through which said blocks are not accessible for cross-connection.

22. The telecommunications interface according to claim 21 in which said plural data connections extend from said first compartment to said second compartment, and including plural voice connections from said feeder blocks in said first compartment to said splitter in said second compartment, whereby digital subscriber line service, and combined voice and digital subscriber line service, can be provided to subscribers by cross-connections made solely in said first compartment.

23. A telecommunications enclosure comprising:
a feeder block;
a distribution block;
subscriber lines coupled to the distribution block; and
a digital subscriber line access multiplexer coupled to the feeder block;
wherein the feeder block and the distribution block are cross-connected to provide voice telecommunications services to said subscribers; and
wherein the digital subscriber line access multiplexer is connected to a digital subscriber line provider adapted to provide digital subscriber line service at least to selected ones of said subscribers.

24. The telecommunications enclosure of claim 23, wherein the feeder block is coupled to a DLC cabinet exterior to the enclosure.
